(19) United States
(12) Patent Application Publication
(10) Pub. No.: US 2026/0289494 A1
(43) Pub. Date: Sep. 24, 2026

(54) METHOD AND SYSTEM OF WAREHOUSE INVENTORY MANAGEMENT

(71) Applicant: Quantiphi, Inc, Marlborough, MA (US)

(72) Inventors: Reghupathi Hariharan, Marlborough, MA (US); Akhil Ram Adapa, Mumbai (IN); Abhishek Kalgutkar, Mumbai (IN); Mohdsaifullah Sadiq Inamdar, Mumbai (IN); Aakarsh Gupta, Mumbai (IN)

(73) Assignee: Quantiphi, Inc, Marlborough, MA (US)

(21) Appl. No.: 19/088,167

(22) Filed: Mar. 24, 2025

(51) Int. Cl. G06Q 10/087; G06Q 30/0202

(52) U.S. Cl. CPC G06Q 10/087; G06Q 10/08; G06Q 10/0872; G06Q 30/0202

(57) ABSTRACT

A method of warehouse inventory management, including obtaining a plurality of raw time series datasets comprising operational transactions indicative of inventory outflow from warehouse. The method includes pre-processing plurality of raw time series datasets to generate a training dataset by filtering data gaps exceeding predetermined duration and type of data records that are less than predefined threshold quantity. The method includes categorizing the pre-processed plurality of raw time series datasets into a number of categories based on distinctive ordering patterns of inventories to generate categorized time series datasets. The method includes processing the categorized time series datasets to generate an augmented training dataset based on inserting data variables associated with seasonality patterns, holiday effects, weather-related features and promotional effects. The method includes dynamically selecting a forecasting model based on the categorization and the augmented training dataset, which is configured to output an actionable demand forecast for inventories of the warehouse.

### FIELD OF TECHNOLOGY

The present disclosure relates generally to the field of warehouse management; and more specifically, to a method and system of warehouse inventory management using automated tracking and real-time data analysis.

### BACKGROUND

In recent years, demand forecasting systems have emerged as significant tools for resource allocation, inventory optimization, and supply chain management. Organizations across distribution, production, and logistics sectors rely on these systems to maintain optimal stock levels and meet end-user requirements. However, traditional demand forecasting approaches, which primarily utilize statistical algorithms, face significant limitations. These conventional methods struggle to adapt to dynamic variables, including shifting consumption patterns, temporal cycles, promotional events, and unexpected disruptions, reducing their effectiveness in complex supply chain environments.

Current demand forecasting systems, for example, BlueYonder Demand Planning, require manual adjustments for periodic events and special activities, introducing potential errors and operational inefficiencies. These systems cannot effectively account for external factors, like environmental conditions or intricate event schedules, resulting in prediction inaccuracies, resource imbalances, and missed fulfillment opportunities. Despite incremental improvements in statistical forecasting methods, these systems inadequately address the multi-dimensional complexity of modern inventory management. As distribution networks expand and diversify, the requirement becomes apparent for an adaptive, automated forecasting solution capable of processing numerous demand-influencing factors with minimal human intervention. Thus, there exists a technical problem concerning manual interventions, stock deficiencies, excess inventory, dynamic variable integration, and suboptimal resource distribution across supply networks.

Further, limitations and disadvantages of conventional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a method for warehouse inventory management using automated tracking and real-time data analysis. The present disclosure provides a solution to the existing problem concerning manual interventions, stock deficiencies, excess inventory, dynamic variable integration, and suboptimal resource distribution across supply networks. An aim of the present disclosure is to provide a solution that overcomes at least partially the problems encountered in the prior art and provide an improved method of warehouse inventory management that dynamically selects predictive models based on distinct supply chain patterns and enriched historical data, thereby optimizing stock levels and reducing resource imbalances across distribution networks.

In one aspect, the present disclosure provides a method of warehouse inventory management, comprising obtaining a plurality of raw time series datasets comprising operational transactions indicative of inventory outflow from a warehouse. The method further comprises pre-processing the plurality of raw time series datasets to generate a training dataset by filtering two or more of: data gaps exceeding a predetermined duration, datasets lacking recent activity, and a type of data records that are less than a predefined threshold quantity. The method further comprises categorising the pre-processed plurality of raw time series datasets into two or more categories based on distinctive ordering patterns of inventories of the warehouse to generate categorized time series datasets. The method further comprises processing the categorized time series datasets to generate an augmented training dataset based on inserting data variables associated with seasonality patterns, holiday effects, weather-related features, and promotional effects that collectively influence the inventory outflow from the warehouse. The method further comprises dynamically selecting a forecasting model from a plurality of available forecasting models for each time series dataset based on the categorization and the augmented training dataset and outputting an actionable demand forecast for the inventories of the warehouse using the selected forecasting model for each time series category to minimize out-of-stock and overstocking in the warehouse.

The disclosed method of warehouse inventory management that revolutionizes demand forecasting through a sophisticated, multi-layered approach. The method systematically transforms raw time series datasets of inventory outflow by implementing comprehensive pre-processing techniques that filter out data gaps, remove inactive datasets, and ensure sufficient historical transaction records. By categorizing the raw time series datasets into high, medium, and low categories based on distinctive ordering patterns and extracted features, the method creates a nuanced framework for inventory analysis. The approach innovates through intelligent data augmentation, incorporating complex external variables, like seasonality patterns, holiday effects, weather-related features, and promotional influences. The dynamic two-layer forecasting model selection mechanism is used assign and evaluate models across different packaging groups, ensuring precise prediction accuracy. The method further incorporates advanced techniques, such as time series decomposition, weather anomaly detection, and customized encoding of promotional features to generate refined, actionable demand forecasts. By continuously monitoring and reassigning categories and forecasting models, the method provides a flexible, intelligent approach that minimizes out-of-stock scenarios and overstock risks, ultimately optimizing warehouse inventory management through data-driven, contextually aware predictive modelling.

In another aspect, the present disclosure provides a system of warehouse inventory management, comprising a processor configured to obtain a plurality of raw time series datasets comprising operational transactions indicative of inventory outflow from a warehouse. The processor is further configured to pre-process of the plurality of raw time series datasets to generate a training dataset by filtering two or more of: data gaps exceeding a predetermined duration, datasets lacking recent activity, and a type of data records that are less than a predefined threshold quantity. The processor is further configured to categorize the pre-processed plurality of raw time series datasets into two or more categories based on distinctive ordering patterns of inventories of the warehouse to generate categorized time series datasets. The processor is further configured to process the categorized time series datasets to generate an augmented training dataset based on inserting data variables associated with seasonality patterns, holiday effects, weather-related features and promotional effects that collectively influence the inventory outflow from the warehouse. The processor is further configured to dynamically select a forecasting model from a plurality of available forecasting models for each time series dataset based on the categorization and the augmented training dataset and output an actionable demand forecast for the inventories of the warehouse using the selected forecasting model for each time series category to minimize out-of-stock and overstocking in the warehouse.

The disclosed system of warehouse inventory management achieves all the advantages and technical effects of the method of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not too scaled. Wherever possible, like elements have been indicated by identical numbers.

Embodiments of the present disclosure will now be described, by way of example only, with reference to the following diagrams wherein:

FIGS. 1A-1H collectively, is a flowchart of a method of warehouse inventory management, in accordance with an embodiment of the present disclosure;

FIG. 2A is a network environment diagram that illustrates various exemplary components of a system of warehouse inventory management, in accordance with an embodiment of the present disclosure;

FIG. 2B is a block diagram illustrating various exemplary components of a server, in accordance with an embodiment of the present disclosure;

FIG. 3 is a flowchart that depicts a series of operations performed by a categorization logic module, in accordance with an embodiment of the present disclosure;

FIG. 4 is a flowchart that depicts a series of operations performed by a seasonality module, in accordance with an embodiment of the present disclosure;

FIG. 5 is a flowchart that depicts a series of operations performed by a weather module, in accordance with an embodiment of the present disclosure;

FIG. 6 is a flowchart that depicts a series of operations performed by a promotion module, in accordance with an embodiment of the present disclosure;

FIG. 7 is a flowchart that depicts a series of operations performed by a hybrid model selection module, in accordance with an embodiment of the present disclosure; and

FIG. 8 is a flowchart that depicts a series of operations performed by a voting ensemble module, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

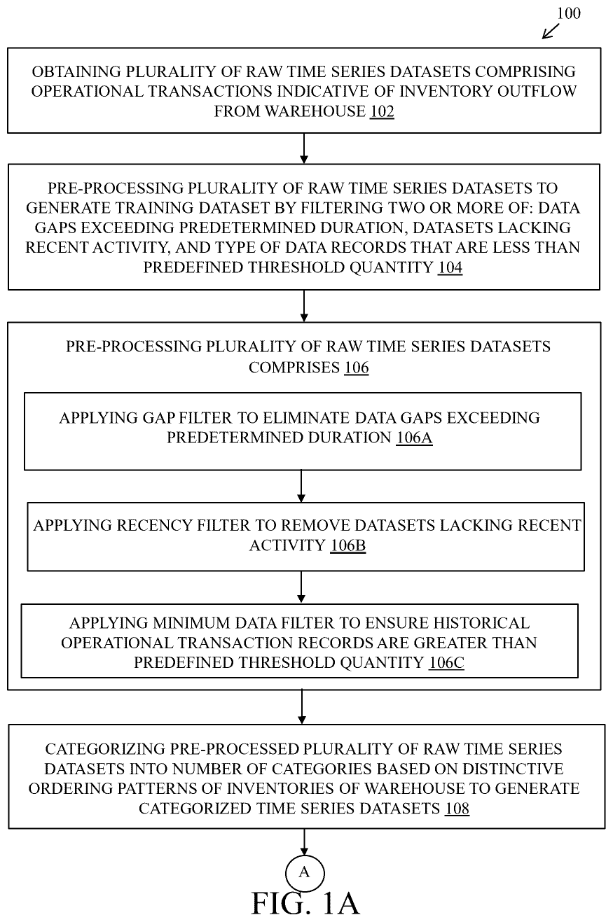

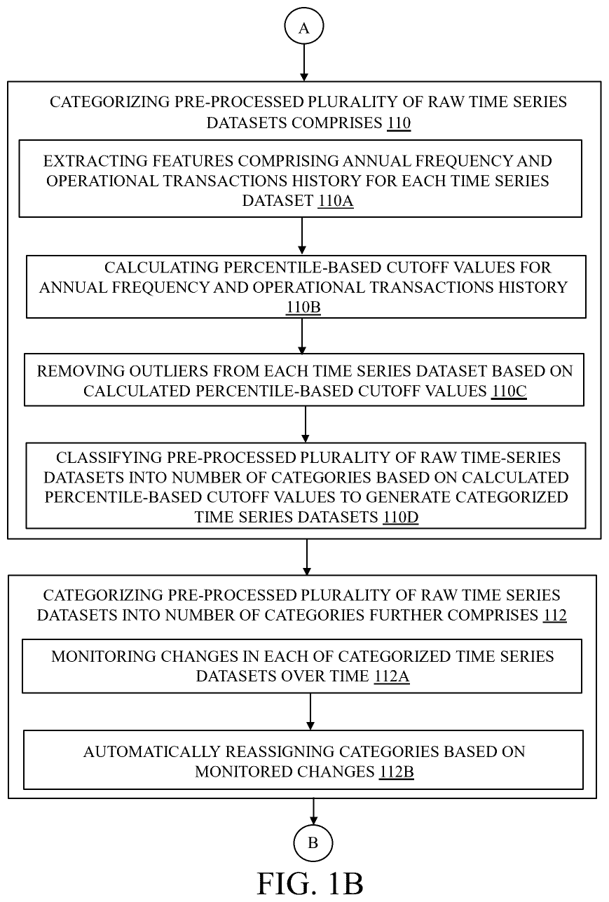

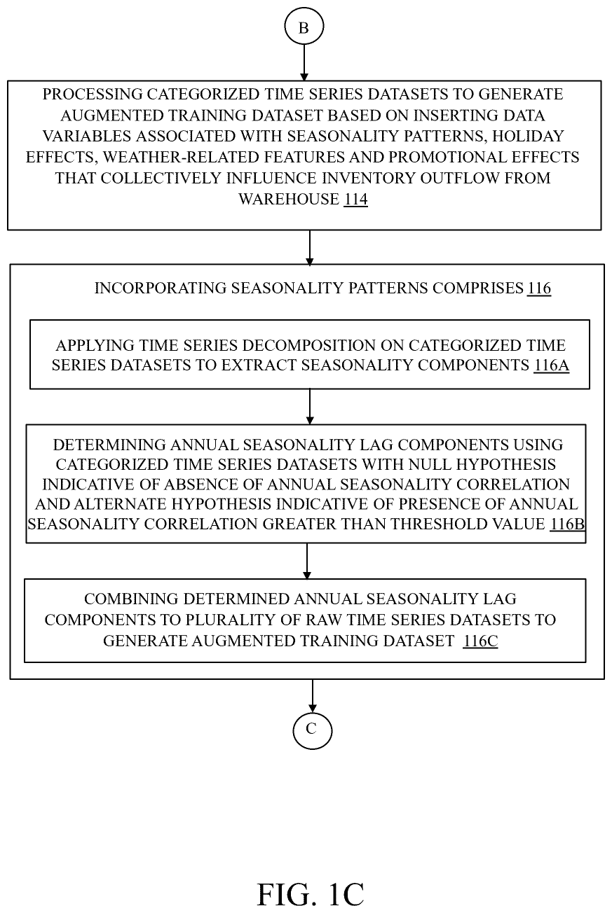

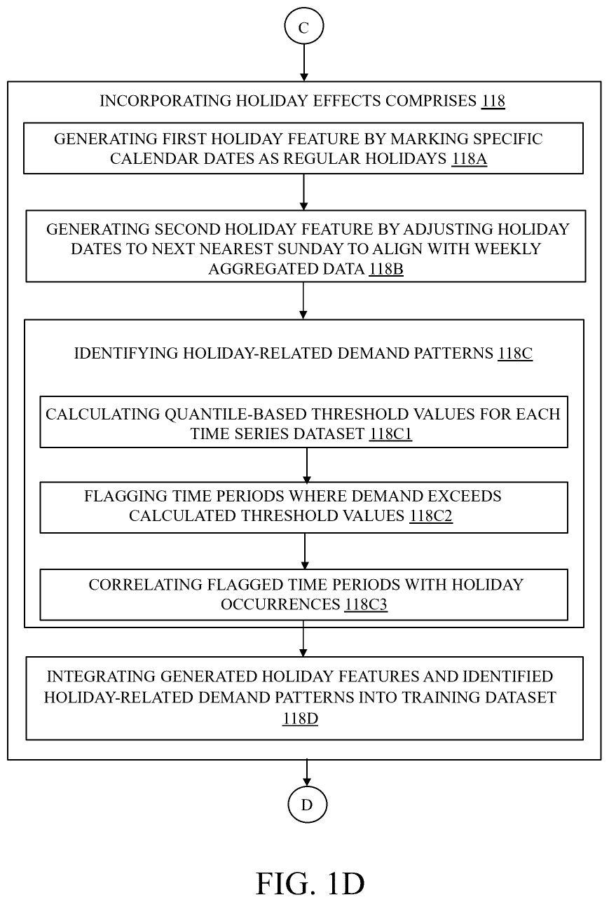

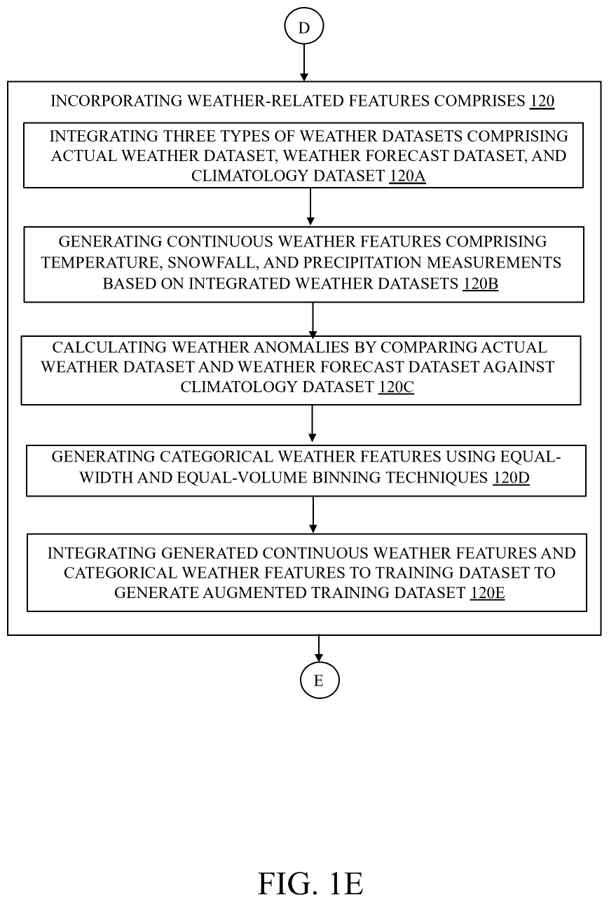

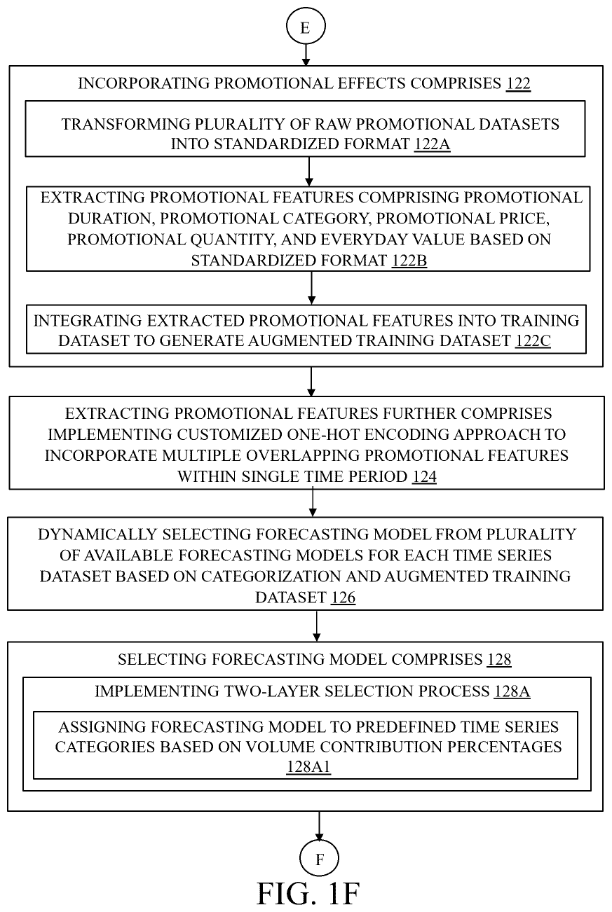

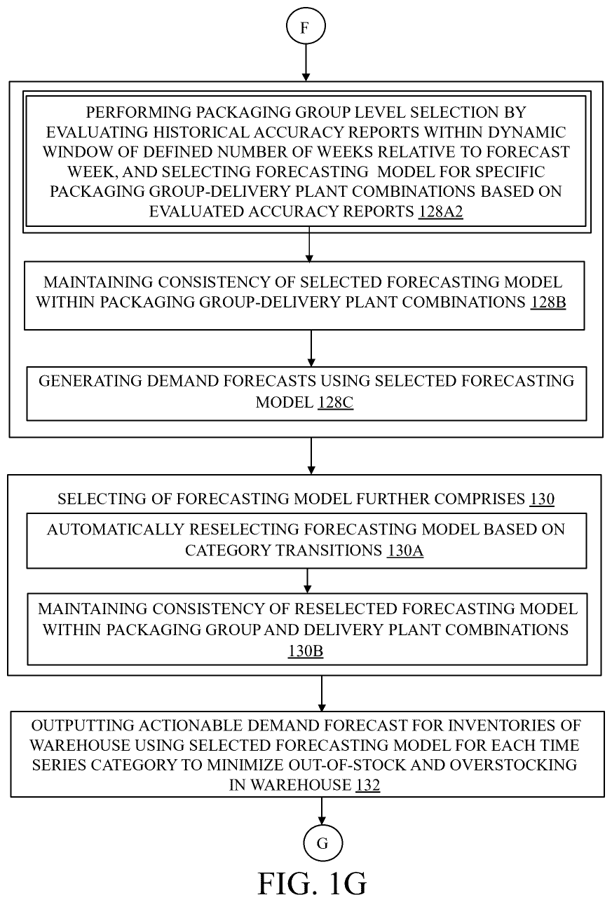

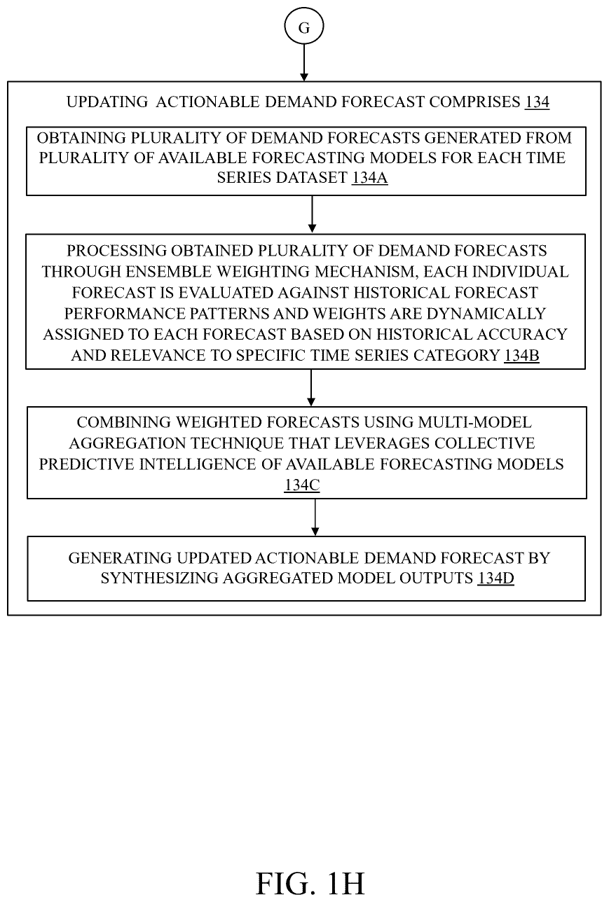

FIGS. 1A-1H collectively, is a flowchart of a method of warehouse inventory management, in accordance with an embodiment of the present disclosure. With reference to FIG. 1A to FIG. 1H, there is shown a method 100 of warehouse inventory management. The method 100 includes steps 102 to 134. Moreover, the steps 102 to 108 are shown in FIG. 1A, the steps 110 to 112 are shown in FIG. 1B, the steps 114 to 116 are shown in FIG. 1C, the step 118 is shown in FIG. 1D, the step 120 is shown in FIG. 1E, the steps 122 to 128 are shown in FIG. 1F, the steps 128 to 132 are shown in FIG. 1G, and the step 134 is shown in FIG. 1H. Moreover, the step 106 includes sub-steps 106A to 106C, the step 110 includes sub-steps 110A to 110D, the step 116 includes sub-steps 116A to 116C, the step 118 includes sub-steps 118A to 118D, the step 120 includes sub-steps 120A to 120E, the step 122 includes sub-steps 122A to 122C, the step 128 includes sub-steps 128A to 128C, the step 130 includes sub-steps 130A and 130B, and the step 134 includes sub-steps 134A to 134D.

There is provided the method 100 of warehouse inventory management that includes obtaining a plurality of raw time series datasets indicative of operational transactions, pre-processing these datasets by filtering issues like data gaps, inactivity, or insufficient records, and categorizing them based on distinctive ordering patterns. Further, the method 100 augments the training dataset by incorporating variables associated with seasonality, holidays, weather, and promotional effects to account for their influence on inventory outflow. The forecasting model is dynamically selected for each time series dataset based on its categorization, which is used to output an actionable demand forecast aimed at minimizing out-of-stock and overstock scenarios in the warehouse.

Referring to FIG. 1A, at step 102, the method 100 of warehouse inventory management comprises obtaining a plurality of raw time series datasets. The plurality of raw time series datasets comprising operational transactions indicative of inventory outflow from a warehouse. The raw time series datasets encompass transaction records aggregated at multiple levels, such as Delivery Plant, Budget Key Account, and Material levels, reflecting invoice quantities over a period of time. The delivery plant refers to a specific location or facility that stores and distributes inventory to fulfill end-user requirements or downstream supply chain demands. The budget key account represents a strategic user segment that significantly influences operational priorities and resource allocation within an organization's distribution framework. The material refers to any physical item or product tracked in inventory management systems, typically identified by a unique code or identifier. The raw time series datasets serve as foundational data points capturing historical patterns of inventory movement within the warehouse. The raw time series datasets may include diverse operational details, such as product-specific sales volumes, order frequencies, and timestamps, collectively characterizing the inventory outflow dynamics.

At step 104, the method 100 further comprises pre-processing the plurality of raw time series datasets to generate a training dataset by filtering two or more of: data gaps exceeding a predetermined duration, datasets lacking recent activity, and a type of data records that are less than a predefined threshold quantity. At first, a gap filter is applied to eliminate any time series with data gaps exceeding the pre-determined duration (for example, 122 days), effectively removing potentially unreliable or inconsistent data segments. The gap filter is used to maintain the integrity of the datasets by rejecting periods with significant discontinuities. Secondly, a recency filter is applied to focus on data relevance by only considering invoice data generated within specific number of days from (for example, past 91 days) from the pipeline run date, and removing any time series combinations that lack recent activity. The recency filter is used to ensure that the training dataset reflects the current and active operational patterns. Thirdly, a minimum invoice filter is applied, which acts as a quality control mechanism. The minimum invoice filter verifying that each data combination contains sufficient records to enable accurate analysis and demand forecasting. By filtering out the data gaps that exceeding the predetermined duration, datasets lacking recent activity, and the type of data records that are less than the predefined threshold quantity results in removing noise and irrelevant data, thus improving the accuracy and reliability of the training dataset. By filtering out extended data gaps, inactive patterns, and underrepresented records, the method 100 ensures that the model training focuses on statistically significant and current operational patterns. This targeted data cleaning reduces noise in the training process, minimizes computational overhead, and prevents the model from learning from outdated or incomplete data sequences. Additionally, by establishing clear thresholds for data quality and recency, the method 100 creates a more robust and reliable foundation for the forecasting algorithm, leading to more accurate predictions and improved resource allocation decisions.

At step 106, pre-processing the plurality of raw time series datasets is performed. The pre-processing systematically filters the raw time series datasets to remove inconsistent, incomplete, or less informative data points. The pre-processing involves applying three distinct filters: the gap filter is applied to eliminate datasets with data gaps exceeding, for example, 122 days, the recency filter that removes time series combinations without invoices in the past, for example, 91 days, and the minimum invoice filter that ensures sufficient historical data for each combination to enable accurate analysis and demand forecasting.

At sub-step 106A of the step 106, pre-processing the plurality of raw time series datasets comprises applying the gap filter to eliminate the data gaps exceeding the predetermined duration. The gap filter systematically identifies and excludes sections of the time series datasets, where continuous operational transaction records are missing for durations beyond a defined threshold, (e.g., 122 days). The data continuity validation mechanism, strategically filters time series datasets to retain only those exhibiting continuous and substantive historical patterns essential for generating statistically reliable forecasting models. By removing these gaps, the method 100 mitigates the risk of skewed or unreliable analysis caused by fragmented data, thereby improving the quality of the training dataset and enhancing the precision of inventory demand forecasting.

At sub-step 106B of the step 106, pre-processing the plurality of raw time series datasets further comprises applying a recency filter to remove the datasets lacking recent activity. The recency filter evaluates each dataset based on the presence of operational transactions within a defined timeframe, (e.g., past 91 days) from the pipeline run date. The pipeline run date represents the reference point from which the 91-day recency window is calculated. The datasets failing to meet this criterion are excluded from further processing, ensuring that only active and relevant time series are included in the training dataset. By filtering out inactive datasets, the method 100 results in an enhanced accuracy of demand forecasting and prevent outdated data from negatively influencing demand predictions.

At sub-step 106C of the step 106, pre-processing of the plurality of raw time series datasets further comprises applying the minimum data filter to ensure historical operational transaction records are greater than the predefined threshold quantity. The minimum data filter may be configured to selectively screen and retain only the most relevant and pertinent information from the raw time series datasets, thereby reducing the volume of data to be processed or stored. For example, datasets with an insufficient number of records to support meaningful trend analysis or forecasting are identified and removed. By implementing the minimum data filter, the method 100 ensures that only datasets with adequate data points are included in the training process, enabling the generation of accurate and reliable demand forecasts while reducing the risk of errors stemming from insufficient data records.

The pre-processing of the plurality of raw time series datasets enhances the data quality by eliminating gaps exceeding the predetermined duration, filtering out inactive datasets, and ensuring sufficient historical records. These steps improve the reliability of training data, enabling more accurate demand forecasts and optimized warehouse inventory management.

At step 108, the method 100 further comprises categorizing the pre-processed plurality of raw time series datasets into a number of categories based on distinctive ordering patterns of inventories of the warehouse to generate categorized time series datasets. The categorization involves analyzing features such as ordering frequency, volume contributions, and historical transaction trends to group time series datasets with similar behaviors. By grouping the time series into categories, such as high, medium, or low categories, the method 100 tailored the analysis and forecasting for each category. The step 108 facilitates the generation of categorized time series datasets, that the subsequent demand forecasting processes can be customized to address the specific characteristics and variability of each group, thereby enhancing forecast accuracy and inventory optimization.

Now referring to FIG. 1B, at step 110, categorizing the pre-processed plurality of raw time series datasets is performed, which is described in the sub-steps 110A to 110D in the following way.

At sub-step 110A, categorizing the pre-processed plurality of raw time series datasets comprises extracting features including annual frequency and operational transactions history for each time series dataset. The annual frequency feature captures the recurring patterns in inventory transactions over a yearly cycle, leading to identify seasonal trends or periodic ordering behaviors. The operational transaction history feature reflects the volume and frequency of past inventory movements, providing insight into the long-term ordering patterns for each inventory item. The extracted features (i.e., the annual frequency and operational transaction history) serve as significant inputs for clustering or classifying the datasets into categories based on distinctive ordering behaviors. By leveraging the features (i.e., the annual frequency and operational transaction history), the sub-step 110A ensures that the categorization process accurately reflects the unique temporal and transactional characteristics of each dataset, thereby enabling more precise and effective demand forecasting.

At sub-step 110B, categorizing the pre-processed plurality of raw time series datasets comprises calculating percentile-based cutoff values for the annual frequency and the operational transactions history. The cutoff values are derived using statistical methods to segment datasets into distinct groups based on their relative positions within the data distribution. For annual frequency, the cutoff values are used to identify time series datasets with high, medium, or low ordering regularity. By calculating percentile-based cutoff values, such as the 25th, 50th, and 75th percentiles, the sub-step 110B establishes threshold values resulting in identifying normal ranges for both features (i.e., the annual frequency and the operational transactions history). The percentile-based cutoff values enable the categorization of the datasets into a number of categories, for example, high, medium, and low activity groups, ensuring that subsequent analysis and forecasting are tailored to the specific characteristics of each category, thereby improving the accuracy of the demand forecasting model.

At sub-step 110C, categorizing the pre-processed plurality of raw time series datasets comprises removing outliers from each time series dataset based on the calculated percentile-based cutoff values. The outliers are identified as data points that significantly deviate from the established range of annual frequency and operational transaction history determined by the cutoff values. The sub-step 110C identifies the data points that fall significantly outside the range of operational transaction values for a given dataset. By calculating percentile-based cutoff values, such as the 5th and 95th percentiles, the sub-step 110C defines acceptable data boundaries and eliminates outlier values that deviate excessively from these limits. The removal of outliers (or anomalies) ensures that the time series datasets subjected to categorization and forecasting are free from distortions caused by irregular values. The sub-step 110C is performed to enhance the quality and reliability of the categorized time series datasets, leading to more accurate and robust demand forecasting outcomes.

At sub-step 110D, categorizing the pre-processed plurality of raw time series datasets comprises classifying the pre-processed plurality of raw time-series datasets into the number of categories based on the calculated percentile-based cutoff values to generate the categorized time-series datasets. The classification process organizes the time series datasets into distinct categories, for example, high, medium and low categories, that reflect varying levels of inventory movement and demand patterns. For example, the datasets that fall above the upper percentile range may be grouped under a “high” category, indicating frequent or significant inventory movement. Similarly, the datasets within the middle percentile range are grouped under a “medium” category and the datasets below the lower percentile cutoff are grouped under a “low” category. This categorization helps to group the time series datasets with similar characteristics, allowing for more precise forecasting models and targeted analysis. The categorization organizes the time series datasets into distinct groups that reflect varying inventory behaviors, facilitating the application of customized forecasting models and enhancing the overall accuracy and efficiency of inventory management.

By extracting features, like annual frequency and operational transaction history, the method 100 captures key data patterns. Furthermore, calculating the percentile-based cutoff values ensures precise identification of outliers, which are removed to maintain data integrity. The classification of time-series datasets into high, medium, and low categories based on the calculated cutoff values enables targeted analysis and forecasting tailored to specific data characteristics. This structured categorization improves model accuracy, scalability, and adaptability, leading to more effective inventory management and demand forecasting.

At step 112, categorizing the pre-processed plurality of raw time series datasets into the number of categories further comprises the sub-steps 112A and 112B.

At sub-step 112A, categorizing the pre-processed plurality of raw time series datasets into the number of categories further comprises monitoring changes in each of the categorized time series datasets over time. The monitoring involves continuously evaluating the dynamics of annual frequency, operational transaction history, and other relevant features to detect shifts in ordering patterns or inventory behaviors. The sub-step 112A is used to ensure that the categorization remains dynamic and adaptive to evolving inventory trends. As new transactional data is collected, the sub-step 112A tracks shifts (or changes) in ordering patterns, transactional frequencies, and other relevant factors that may indicate a change in the behavior of the time series datasets. In a case, the dataset's characteristics shift significantly, such as an increase or decrease in ordering volume or frequency. In that case, the sub-step 112A allows the automatic reassignment of the dataset to the more appropriate category that better reflects its current behavior.

At sub-step 112B, categorizing the pre-processed plurality of raw time series datasets into the number of categories further comprises automatically reassigning the categories based on the monitored changes. The sub-step 112B involves dynamically evaluating updates in the annual frequency, operational transaction history, and other key features over time to identify shifts in inventory patterns. As the characteristics of the time series datasets evolve, such as changes in ordering frequency or transaction volume, the method 100 dynamically updates the category assignments. If the raw time series dataset shows a significant shift in its ordering patterns or transactional behavior, it is automatically reclassified into the more appropriate category that reflects its current trends. The ability to automatically reassign categories enhances the flexibility of the forecasting process, allowing the sub-step 112B to continuously adapt to real-time data and maintain enhanced forecasting accuracy for warehouse inventory management.

By monitoring changes in the categorized datasets over time, the method 100 ensures that the categorization remains relevant as trends and patterns evolve. This continuous monitoring allows for automatic reassignment of categories based on observed changes, ensuring that the data is always classified in a way that reflects its most current state. This adaptability enhances the accuracy of the categorization process and enables the forecasting model to stay aligned with real-time data shifts, improving the overall predictive performance and adaptability of the method 100.

Now referring to FIG. 1C, at step 114, the method 100 of warehouse inventory management comprises processing the categorized time series datasets to generate an augmented training dataset based on inserting data variables associated with seasonality patterns, holiday effects, weather-related features, and promotional effects that collectively influence the inventory outflow from the warehouse. The seasonality patterns capture recurring fluctuations in inventory demand over time, while holiday effects reflect changes in demand due to specific dates or periods. The weather-related features, such as temperature and precipitation, provide insight into the environmental factors that impact inventory movements. The promotional effects are incorporated by analyzing the impact of marketing and sales promotions on inventory levels. The inclusion of the seasonality patterns, holiday effects, weather features, and promotional impacts in the augmented training dataset improves the model's understanding of factors influencing inventory outflow from the warehouse.

At step 116, incorporating the seasonality patterns further comprises the sub-steps 116A-116C.

At sub-step 116A, incorporating the seasonality patterns comprises applying time series decomposition on the categorized time series datasets to extract seasonality components. The time series decomposition is used to break down each dataset into its underlying components, including level, trend, seasonality, and noise. The seasonality component captures the periodic fluctuations in inventory demand that occur at regular intervals, such as annual, monthly, or weekly cycles. The extracted seasonality information provides valuable insights into predictable fluctuations in demand, allowing the forecasting model to account for these patterns and enhance the accuracy of inventory predictions.

At sub-step 116B, incorporation of the seasonality patterns comprises determining the annual seasonality lag components using the categorized time series datasets with a null hypothesis indicative of an absence of annual seasonality correlation and an alternate hypothesis indicative of the presence of an annual seasonality correlation greater than a threshold value. The null hypothesis is formulated, indicating the absence of the annual seasonality correlation, while the alternate hypothesis indicates the presence of the significant annual seasonality correlation exceeding the predefined threshold value. The categorized time series datasets are subjected to test hypotheses (i.e., the null hypothesis and the alternative hypothesis), determining whether annual seasonality patterns exist and, if so, quantifying their impact. By conducting the test hypotheses (i.e., the null hypothesis and the alternative hypothesis), the sub-step 116B identifies whether the seasonal patterns in inventory outflow exhibit a consistent annual cycle. Suppose, the test reveals a significant annual correlation, in that case, the corresponding annual seasonality lag components are incorporated into the forecasting model, allowing for more accurate predictions that reflect the expected cyclical variations in demand based on the seasonal patterns observed in the time series data.

At sub-step 116C, incorporation of the seasonality patterns comprises combining the determined annual seasonality lag components to the plurality of raw time series datasets to generate the augmented training dataset. Once the annual seasonality lag components (including level, trend, seasonality, and noise) have been identified through statistical analysis, these components, which capture the periodic fluctuations in demand based on annual cycles, are integrated with the plurality of raw time series datasets to generate the augmented training dataset. The augmented training dataset is used for training of the forecasting model to account for seasonal variations more effectively, improving the model's ability to predict future inventory outflows with higher accuracy. The augmented training dataset explicitly captures recurring seasonal dynamics, enabling more precise demand forecasting by accounting for predictable inventory outflow variations across annual cycles.

Applying time series decomposition extracts seasonality components, enabling a detailed understanding of recurring patterns. The determination of annual seasonality lag components, based on hypothesis testing, ensures the inclusion of only statistically significant correlations, enhancing the accuracy of seasonal insights. By combining these lag components with the plurality of raw time series datasets to create the augmented training dataset, the method 100 improves model training, enabling more precise demand forecasting and better alignment with real-world seasonal fluctuations.

Now referring to FIG. 1D, at step 118, incorporation of holiday effects comprises the steps 118A-118D.

At sub-step 118A, incorporating the holiday effects comprises generating a first holiday feature by marking specific calendar dates as regular holidays. The sub-step 118A involves identifying and designating certain dates, such as New Year's Day or Independence Day, and directly tagging these dates as holiday-specific features within the time series datasets. These dates are flagged as “regular holidays” to account for their potential impact on inventory demand patterns. The sub-step 118A is used to capture the unique impact of holidays on inventory demand, which often includes spikes or dips in activity due to changes in consumer behavior. The holiday-specific markers are integrated into the datasets to enhance the forecasting model's ability to predict variations in inventory outflow that are directly attributable to holidays, improving forecast accuracy and aligning predictions with real-world demand patterns.

At sub-step 118B, incorporating the holiday effects comprises generating a second holiday feature by adjusting holiday dates to next nearest Sunday to align with weekly aggregated data. The adjustment is made to the time series datasets, which are aggregated on the weekly basis, and holiday effects often span multiple days, potentially disrupting the alignment with the weekly data structure. For instance, if a holiday falls on a Wednesday, it is shifted to the following Sunday to match the structure of the weekly aggregated data. By aligning holiday impacts with weekly aggregated data, the sub-step 118B is used to enhance the forecasting model's ability to recognize and account for variations in demand attributable to holidays, providing a more precise representation of their effects on inventory outflow.

At sub-step 118C, incorporating the holiday effects comprises identifying holiday-related demand patterns. The sub-step 118C further includes three sub-steps 118C1, 118C2 and 118C3. At sub-step 118C, the method 100 involves calculating quantile-based threshold values for each time series dataset to establish a baseline for normal demand levels. The time periods where demand exceeds these calculated thresholds are flagged, indicating a potential holiday-related demand spike. By calculating the quantile-based threshold values for demand within each dataset, the sub-step 118C flags time periods where demand significantly deviates from the normal levels. The flagged periods are then correlated with holiday occurrences to discern patterns, such as increased demand for certain products during festive seasons or reduced demand during non-business holidays.

At sub-step 118C1 of the sub-step 118C, the method 100 comprises identifying holiday-related demand patterns by calculating quantile-based threshold values for each time series dataset. The sub-step 118C1 involves analyzing the historical demand data within each dataset to establish a baseline for normal demand levels. The sub-step 118C1 is used to calculate quantile-based threshold values, which define the demand levels at specific percentiles, such as the 75th or 90th percentile, based on past performance. For example, the sub-step 118C1 may calculate, for example, a 25th and 75th percentiles to determine the lower and upper bounds of typical demand pattern. The quantile-based threshold values are used to identify deviations that signify holiday-related demand anomalies, such as unusually high or low inventory outflows during holiday periods. By establishing the quantile-based threshold values, the sub-step 118C1 is used to provide a robust framework for detecting and quantifying the impact of holidays on inventory demand, enabling the forecasting model to incorporate these effects and improve prediction accuracy.

At sub-step 118C2, identifying holiday-related demand patterns by flagging time periods where demand exceeds the calculated threshold values. The sub-step 118C2 involves reviewing the time series datasets and identifying specific periods when demand levels surpass the previously calculated quantile-based threshold values, which are indicative of regular demand patterns. When demand exceeds the calculated threshold value, it is flagged as a potential holiday-related demand spike. The sub-step 118C2 is used to ensure that the forecasting model can effectively account for and adjust to these demand fluctuations, improving the precision of inventory predictions and supporting more efficient inventory management during high-demand periods.

At sub-step 118C3, identifying holiday-related demand patterns by correlating the flagged time periods with holiday occurrences. The sub-step 118C3 involves matching the time periods where demand exceeded the calculated threshold values with specific holiday dates in the calendar. Following the identification of demand anomalies in sub-step 118C2, the sub-step 118C3 is used to cross-reference the flagged periods with known holiday dates to establish a direct relationship between the observed demand fluctuations and specific holidays. This correlation process supports the inclusion of attributes of spikes or dips in inventory outflow to the influence of holidays, distinguishing them from other potential factors.

At sub-step 118D, the method 100 comprises integrating the generated holiday features and identified holiday-related demand patterns into the training dataset. The sub-step 118D involves incorporating both the generated holiday feature, which marks specific calendar dates as regular holidays, and the identified holiday feature, which adjusts holiday dates to the nearest Sunday to align with weekly aggregated data. By including these features, the training dataset is enriched with information that captures the unique influence of holidays on inventory outflows, such as demand spikes during festive seasons or reduced activity during non-business holidays. The integration the generated holiday features and identified holiday-related demand patterns into the training dataset ensures that the forecasting model can learn from these patterns and accurately account for holiday-related variations in demand, improving the forecasting model's ability to make precise and reliable predictions for inventory management.

By generating the two distinct holiday features, one marking specific calendar dates as regular holidays and another adjusting holiday dates to the nearest Sunday, the method 100 ensures that the data is aligned with both calendar and weekly cycles. Additionally, the identification of holiday-related demand patterns through quantile-based threshold values allows for the detection of significant demand surges, flagging periods where demand exceeds expected levels. By correlating these flagged periods with holiday occurrences, the method 100 enables the model to learn more precisely how holidays influence demand. Integrating these holiday features and demand patterns into the training dataset enhances the model's ability to predict and optimize sales strategies around holiday periods, improving overall forecasting accuracy and decision-making.

Now referring to FIG. 1E, at step 120, incorporation of the weather-related features comprises the sub-steps 120A-120D.

At sub-step 120A, incorporating the weather-related features comprises integrating three types of weather datasets comprising an actual weather dataset, a weather forecast dataset, and a climatology dataset. The actual weather dataset includes real-time weather measurements, providing up-to-date information on variables such as temperature, precipitation, and other environmental factors that may influence inventory demand. The weather forecast dataset contains predictions for future weather conditions, typically covering a short-term period, such as next six weeks. The climatology dataset includes long-term average weather data, typically spanning several years, which serves as a baseline for expected weather patterns. By combining these datasets, the sub-step 120A is used to create a comprehensive view of weather influences on inventory demand, enabling the forecasting model to account for both historical trends and anticipated weather impacts. The integration enhances the forecasting model's ability to predict demand fluctuations driven by weather conditions, ensuring more accurate and weather-aware inventory management.

At sub-step 120B, incorporating the weather-related features comprises generating continuous weather features comprising temperature, snowfall, and precipitation measurements based on the integrated weather datasets. The continuous weather features are derived from the actual weather dataset, the weather forecast dataset, and the climatology dataset. Temperature, snowfall, and precipitation are key environmental variables that can significantly impact inventory demand, especially for products sensitive to weather conditions, such as seasonal items (or consumer products). For instance, the temperature feature captures daily or weekly average temperatures, while snowfall and precipitation features quantify the total amounts recorded over corresponding time periods. By incorporating the continuous weather features into the training dataset, the forecasting model is equipped to recognize and account for weather-driven demand patterns, enhancing prediction accuracy and inventory management efficiency.

At sub-step 120C, incorporating the weather-related features comprises calculating weather anomalies by comparing the actual weather data set and the weather forecast data set against the climatology data set. The climatology data set provides the long-term average weather conditions, serving as a baseline for what is considered “normal” weather. The actual weather data set reflects the current, real-time conditions, while the weather forecast data set offers predictions for upcoming weather. For example, if the actual temperature in a given week deviates significantly from the climatological average, this difference is considered as an anomaly. The calculated weather anomalies, such as temperature, snowfall, and precipitation deviations cause the method 100 to capture unusual or extreme weather events that may influence inventory demand. By comparing these datasets, the sub-step 120C identifies deviations or anomalies instances where the actual or forecasted weather significantly differs from the expected climatological norms.

At sub-step 120D, incorporating the weather-related features comprises generating categorical weather features using equal-width and equal-volume binning techniques. The binning technique is applied to the continuous weather data, such as temperature, snowfall, and precipitation measurements, to convert them into categorical variables that can be more easily integrated into the forecasting model. In equal-width binning, the weather data range is divided into intervals of equal size, creating categories based on predefined weather ranges (e.g., temperature ranges such as 0-10° C., 11-20° C., etc.). In equal-volume binning, the data is divided into intervals that each contain an equal number of data points, ensuring that each bin holds a similar distribution of weather conditions. The categorical weather features allow the forecasting model to capture the impact of varying weather conditions on inventory demand by grouping weather data into manageable categories.

At sub-step 120E, integrating the generated continuous weather features and the categorical weather features to the training dataset to generate the augmented training dataset. By including the continuous weather features and the categorical weather features in the training dataset, the sub-step 120E is used to improve the forecasting model's ability to recognize and respond to weather-driven demand patterns, ensuring more accurate and contextually relevant inventory forecasts.

By integrating the actual, forecast, and climatology weather datasets, the method 100 ensures comprehensive coverage of historical, current, and expected weather conditions. The continuous weather features, such as temperature, snowfall, and precipitation are derived to capture quantitative weather impacts, while anomalies are calculated by comparing actual and forecast datasets against the climatology dataset to highlight deviations. Additionally, the categorical weather features are created using equal-width and equal-volume binning techniques, enabling a more structured representation of weather data. The integration of these features into the training dataset results in an augmented dataset that improves the model's ability to account for weather influences, enhancing the precision and reliability of demand forecasts.

Now referring to FIG. 1F, at step 122, the method 100 comprises incorporating the promotional effects into the training dataset. The incorporation of the promotional effects comprises the sub-steps 122A-122C.

At sub-step 122A, incorporating the promotional effects comprises transforming a plurality of raw promotional datasets into a standardized format. The raw promotional datasets initially maintained in an unstructured or inconsistent format, typically contain information, such as promotional duration, type, price, and quantity. The transformation process ensures that all promotional data, such as promotional duration, promotional category, promotional price, and promotional quantity is uniformly formatted, making it compatible for integration with other datasets used in forecasting models. The standardized format enables seamless integration of the promotional data with other features, such as inventory and weather data, and ensures that the forecasting model can effectively incorporate the impact of promotions on inventory demand. By standardizing the promotional datasets, the sub-step 122A is used to facilitate more accurate forecasting by ensuring that promotional effects are consistently accounted in the forecasting model.

At sub-step 122B, incorporating the promotional effects comprises extracting promotional features comprising promotional duration, promotional category, promotional price, promotional quantity, and everyday value based on the standardized format. The extracted promotional features include promotional duration which captures the number of days the promotion is active, the promotional category which classifies the type of promotion (e.g., buy-1-get-1, discount offers), the promotional price reflecting the price of the product during the promotion, the promotional quantity which indicates the quantity of products involved in the promotion, and everyday value, representing the baseline price of the product in the absence of the promotion. By extracting and organizing these features, the sub-step 122B ensures that the forecasting model can account for the specific effects of promotions on demand, allowing for more accurate predictions of inventory movement during promotional periods.

At sub-step 122C, incorporating the promotional effects comprises integrating the extracted promotional features into the training dataset to generate the augmented training dataset. After extracting key promotional features, such as the promotional duration, the promotional category, the promotional price, the promotional quantity, and everyday value, these features are seamlessly incorporated into the training dataset. The integration ensures that the training dataset reflects the combined influence of both historical inventory demand patterns and promotional activities. By adding the promotional features to the training dataset, the method 100 provides the model with detailed information about promotional activities, enabling the forecasting model to recognize patterns in inventory movement driven by promotions. The augmented training dataset, now enriched with both promotional and other relevant data, allows the forecasting model to make more accurate predictions about inventory outflow, especially during periods of promotional activity, ensuring better stock management and demand forecasting.

By transforming the raw promotional data into the standardized format, the method 100 ensures consistency and comparability across diverse datasets. This standardization process has significance for accurately analyzing and utilizing promotional features, such as duration, category, price, quantity, and everyday value, all of which can significantly influence consumer behavior and sales patterns. The extraction and integration of these key promotional features into the training dataset enables the forecasting model to learn from a rich set of variables, enhancing its predictive accuracy.

At step 124, extracting the promotional features further comprises implementing a customized one-hot encoding approach to incorporate multiple overlapping promotional features within a single time period. The one-hot encoding refers to a method of representing categorical data where each category is represented by a binary vector with only one bit set to 1 and the rest bits set to 0. The one-hot encoding technique allows multiple promotional features to be activated within a single data row without creating unnecessary data duplications. This approach enables the forecasting model to capture the nuanced interactions of overlapping promotions by strategically incorporating multiple promotional characteristics (such as the promotional duration, the promotional category, the promotional price, and the promotional quantity) within the same time period. By applying the customized one-hot encoding technique, the method 100 ensures that the impact of simultaneous promotional activities is accurately reflected in the training dataset, leading to more precise demand forecasting during promotional periods.

By implementing a tailored one-hot encoding strategy, the method 100 ensures that each overlapping promotional feature, such as the promotional category, price, or quantity is accurately captured and represented in the model without losing crucial information. This approach allows the model to distinguish between and learn from the various combinations of promotional factors in a given time period, thereby improving the model's ability to capture nuanced patterns in consumer behavior and optimize promotional strategies.

At step 126, the method 100 comprises dynamically selecting a forecasting model from a plurality of available forecasting models for each time series dataset based on the categorization and the augmented training dataset. The selection is based on the categorization of the time series datasets and the augmented training dataset, which includes additional features, such as seasonality, holiday effects, weather-related factors, and promotional influences. Based on the dataset's category, whether high, medium, or low category, the method 100 selects the most appropriate forecasting model from the set of models, such as Prophet, LightGBM, or AutoARIMA. This dynamic selection process ensures that the forecasting model chosen is best suited to the specific nature of the time series data, optimizing forecasting accuracy. By tailoring the model selection to the unique attributes of each dataset, the method 100 enhances the precision of inventory demand predictions and improves overall inventory management.

At step 128, selecting the forecasting model comprises sub-steps 128A to 128C.

At sub-step 128A, the method 100 comprises implementing a two-layer selection process including the sub-steps 128A1 and 128A2.

At sub-step 128A1, implementing the two-layer selection process comprising assigning the forecasting model to predefined time series categories based on volume contribution percentages. In the sub-step 128A, each time series dataset is evaluated to determine its relative contribution to the overall inventory volume, and the datasets are grouped into categories such as high, medium, or low volume based on these contributions. Time series datasets that contribute a larger percentage to the total inventory volume are assigned more robust forecasting models that can handle higher data complexity and variability, while smaller-volume datasets are assigned simpler models. This tailored assignment process ensures that each time series dataset is paired with the most appropriate forecasting model, enhancing the accuracy and efficiency of demand forecasting across different inventory categories. By aligning the forecasting model to the volume contribution of each dataset at the sub-step 128A, the method 100 ensures the warehouse inventory management with efficacy.

Now referring to FIG. 1G, at sub-step 128A2, implementing the two-layer selection process further comprising performing a packaging group level selection by evaluating historical accuracy reports within a dynamic window of defined number of weeks relative to a forecast week, and selecting the forecasting model for specific packaging group-delivery plant combinations based on the evaluated accuracy reports. The sub-step 128C focuses on assessing the past performance of various forecasting models for specific packaging groups and delivery plant combinations. By analyzing the historical accuracy reports, the sub-step 128C is used to identify which forecasting models have delivered the most accurate predictions for particular combinations in the past. Based on this evaluation, the sub-step 128C is used to select the most suitable forecasting model for each packaging group-delivery plant combination, ensuring that the model chosen is best aligned with the historical demand patterns and forecasting accuracy for that specific group. This dynamic selection process allows for continuous optimization, improving the precision of demand forecasts and enhancing inventory management across different product and distribution categories.

At sub-step 128B, the method 100 further comprises maintaining consistency of the selected forecasting model within packaging group-delivery plant combinations. Once a forecasting model has been assigned to a specific time series category, the sub-step 128B is used to ensure that the same forecasting model is consistently applied to the relevant packaging group and delivery plant combinations over time. By maintaining this consistency, the sub-step 128B reduces the requirement for frequent re-selection of forecasting models, which could lead to instability or inefficiency in the forecasting process. This approach is used for selected forecasting models that remain aligned with the historical demand patterns and forecasting accuracy for that specific packaging group and delivery plant combination, enabling more reliable and stable demand forecasts.

At sub-step 128C, the method 100 further comprises generating a demand forecast using the selected forecasting model. Once the most appropriate forecasting model has been dynamically assigned to a specific time series category, based on factors, like volume contribution and historical accuracy, the sub-step 128C involves using that forecasting model to generate predictions for future inventory demand. The selected model, tailored to the characteristics of the dataset, processes the augmented training data and applies its forecasting algorithms to produce demand predictions. The generated demand forecast provides critical insights into expected inventory outflows, leading to optimize stock levels and prevent issues, such as overstocking or stockouts conditions.

The first layer assigns forecasting models to predefined time series categories based on volume contribution percentages, ensuring an optimal model for each category. The second layer refines the selection by evaluating historical accuracy within a dynamic window of defined weeks and choosing the most suitable model for specific packaging group-delivery plant combinations. By leveraging this structured and adaptive selection process, the method 100 enhances demand forecast accuracy, scalability, and alignment with operational requirements.

At step 130, selecting of the forecasting model further comprises the sub-steps 130A and 130B.

At sub-step 130A, selecting of the forecasting model further comprises automatically reselecting the forecasting model based on category transitions. The sub-step 130A is used for the forecasting model to remain aligned with any changes in the characteristics of the time series data over time. As inventory patterns evolve, a time series dataset may transition from one category to another, such as moving from a “low” to a “medium” or “high” activity category due to changes in ordering patterns, seasonal variations, or other factors. When such category transitions occur, the sub-step 130A is used to automatically reassign a new forecasting model that is better suited to the updated category. This dynamic re-selection process allows to adapt to shifting demand patterns, ensuring that the most appropriate and effective forecasting model is always used, thereby maintaining the accuracy of demand forecasts and optimizing inventory management.

At sub-step 130B, selecting of the forecasting model further comprises maintaining consistency of the reselected forecasting model within packaging group and delivery plant combinations. When a category transition triggers the re-selection of the forecasting model, the sub-step 130B is used to choose the new forecasting model and remains consistent for the specific packaging group and delivery plant combination. The consistency prevents frequent model changes within the same combination, which could lead to instability and inconsistencies in demand forecasting. By maintaining the same forecasting model across multiple forecasting cycles for the same packaging group and delivery plant, the sub-step 130B is used to make predictions that are reliable and aligned with past performance for those specific combinations.

By maintaining consistency of the reselected forecasting model within specific packaging group and delivery plant combinations, the method 100 ensures that the model remains relevant to the specific operational context, reducing variability and improving forecasting reliability across different combinations. This dynamic model re-selection enhances the method's ability to provide accurate, context-sensitive demand forecasts while maintaining stability in forecasting performance.

At step 132, the method 100 further comprises outputting an actionable demand forecast for the inventories of the warehouse using the selected forecasting model for each time series category to minimize out-of-stock and overstocking in the warehouse. This step involves generating the demand forecast with precision based on the specific forecasting model that has been dynamically selected for each category, taking into account various factors, such as historical demand, seasonality, promotional effects, and other relevant variables. By tailoring the forecasting model to the unique characteristics of each time series category, the method 100 provides more accurate and actionable demand forecast.

Now referring to FIG. 1H, at step 134, updating the actionable demand forecast comprises the sub-steps 134A to 134D.

At sub-step 134A, updating the actionable demand forecast by obtaining a plurality of demand forecasts generated from the plurality of available forecasting models for each time series dataset. In the sub-step 134A, multiple forecasting models, such as Prophet, LightGBM, or AutoARIMA, and the like, are applied to the same time series dataset, generating a range of demand forecasts based on the different methodologies and assumptions of each model. This approach allows for a broader perspective on potential demand outcomes, incorporating the strengths and insights of each model. By gathering these diverse forecasts, the sub-step 134A provides a comprehensive set of predictions that reflect various possible scenarios, which can then be further refined or aggregated to improve the overall accuracy and reliability of the demand forecast for inventory management.

At sub-step 134B, updating the actionable demand forecast by processing the obtained plurality of demand forecasts through an ensemble weighting mechanism, wherein each individual forecast is evaluated against historical forecast performance patterns and weights are dynamically assigned to each forecast based on the historical accuracy and relevance to the specific time series category. Each individual forecast generated from different available forecasting models is evaluated against historical forecast performance patterns to assess accuracy and relevance to the specific time series category. The historical accuracy is considered to determine the model's past performance in predicting demand, while relevance to the current time series category ensures the inclusion of the most suitable forecasts. Based on these evaluations, dynamic weights are assigned to each forecast, with higher weights allocated to forecasts demonstrating greater accuracy and relevance. The ensemble weighting mechanism combines the forecasts from multiple models into a single, refined demand prediction, enhancing reliability and precision. By leveraging this ensemble weighting mechanism, the sub-step 134B provides the improved forecast accuracy, enhancing warehouse inventory management by providing more robust and contextually accurate demand predictions.

At sub-step 134C, updating the actionable demand forecast by combining the weighted forecasts using a multi-model aggregation technique that leverages a collective predictive intelligence of the available forecasting models. The sub-step 134C involves integrating the individual forecasts, each assigned a weight based on its historical accuracy and relevance, into a unified demand prediction. The multi-model aggregation technique leverages the collective predictive intelligence of the available forecasting models, pooling the strengths of each forecasting model to enhance overall forecast accuracy. By combining the outputs of multiple models, the sub-step 134C mitigates the risk of relying on a single model's potentially biased or inaccurate prediction. This collective approach enhances the overall forecasting process, leading to more reliable and precise demand predictions for inventory management, helping to optimize stock levels and reduce forecasting errors.

At sub-step 134D, updating the actionable demand forecast by generating an updated actionable demand forecast by synthesizing the aggregated model outputs. After combining the weighted forecasts using a multi-model aggregation technique in sub-step 134C, the sub-step 134D involves creating the updated demand forecast that incorporates the collective insights from all the forecasting models. The aggregated outputs, which reflect diverse forecasting approaches and historical performance, are synthesized into a single, cohesive forecast that is actionable for inventory management. This updated demand forecast provides a more accurate and reliable prediction of future inventory demand, taking into account various factors, such as seasonality, promotions, weather patterns, and historical data. By generating this actionable demand forecast, the sub-step 134D enables more informed decision-making, leading to optimize stock levels, minimize the risk of overstocking or stockouts, and improve overall warehouse inventory management.

By obtaining the demand forecasts from the plurality of models, the method 100 ensures that diverse perspectives and forecasting techniques are considered, enhancing the overall robustness of the prediction. The ensemble weighting mechanism, which evaluates each individual forecast against its historical accuracy and relevance to the specific time series category, allows the method 100 to assign higher weight to more reliable forecasts, improving prediction precision. The weighted forecasts are then aggregated using the multi-model technique, harnessing the collective predictive power of the models. This results in the updated actionable demand forecast, improving prediction accuracy and enhancing decision-making for more effective demand planning.

The method 100 of warehouse inventory management represents a transformative approach to demand forecasting by introducing a comprehensive, multi-layered methodology that addresses critical limitations of conventional inventory management systems. Unlike traditional methods, the method 100 provides a sophisticated pre-processing technique that filters raw time series datasets using gap, recency, and minimum data filters, ensuring only meaningful operational transaction data is utilized. The method 100 integrates external variables, like seasonality, holidays, weather, and promotions through sophisticated filtering and model selection techniques. Using the two-layer approach with the voting ensemble mechanism, the method 100 generates precise, and the actionable demand forecast while automatically adapting to changing data patterns. The method 100 can automatically reassign categories and models as data patterns evolve, addressing the primary limitation of static forecasting methodologies. The result is a robust approach that minimizes out-of-stock and overstocking scenarios, providing a more adaptive and accurate warehouse inventory management solution.

The steps 102 to 134 are only illustrative, and other alternatives can also be provided where one or more steps are added, or one or more steps are provided in a different sequence without departing from the scope of the claims herein.

There is provided a computer program product comprising instructions for performing the method 100 when executed by one or more processors. The computer program is implemented as an algorithm, embedded in a software stored in the non-transitory computer-readable storage medium having program instructions stored thereon, the program instructions being executable by the one or more processors in the computer system to execute the method 100. The non-transitory computer-readable storage means may include but are not limited to, an electronic storage device, a magnetic storage device, an optical storage device, an electromagnetic storage device, a semiconductor storage device, or any suitable combination of the foregoing. Examples of implementation of computer-readable storage medium, but are not limited to, an Electrically Erasable Programmable Read-Only Memory (EEPROM), a Random Access Memory (RAM), a Read Only Memory (ROM), a Hard Disk Drive (HDD), a Flash memory, a Secure Digital (SD) card, a Solid-State Drive (SSD), a computer-readable storage medium, and/or a CPU cache memory.

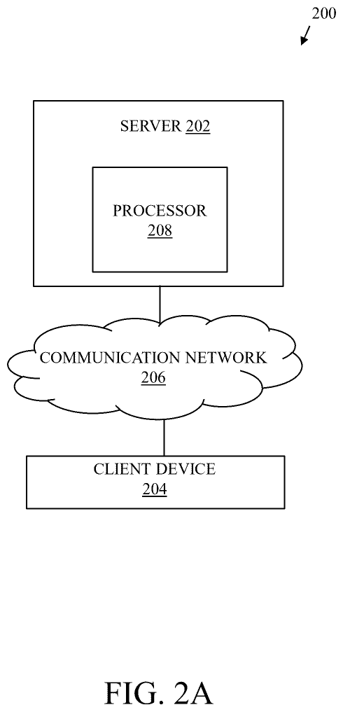

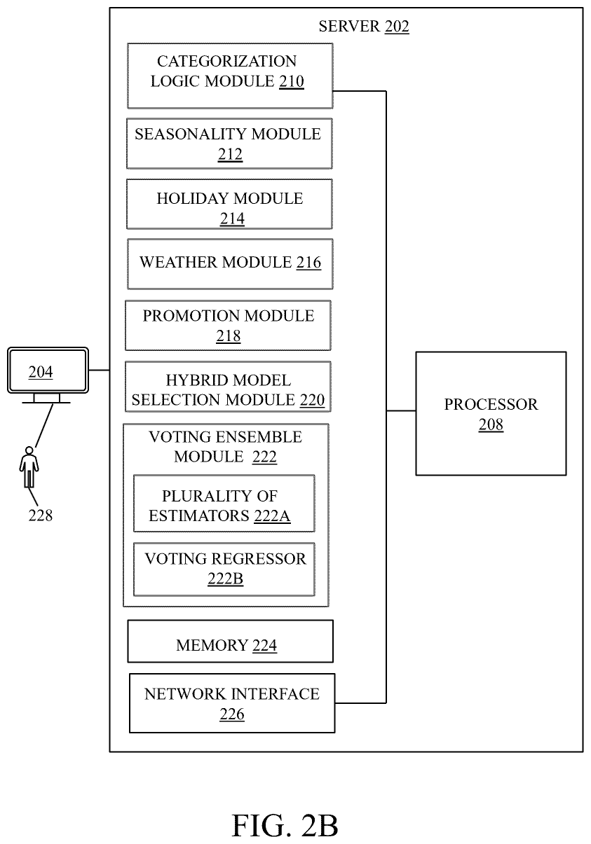

FIG. 2A is a network environment diagram that illustrates various exemplary components of a system of warehouse inventory management, in accordance with an embodiment of the present disclosure. With reference to FIG. 2A, there is shown a system 200 of warehouse inventory management. The system 200 comprises a server 202 connected to a client device 204 through a communication network 206. The server 202 comprises a processor 208. The processor 208 of the server 202 is configured to execute the method 100 (of FIGS. 1A to 1H).

The system 200 of warehouse inventory management is designed to streamline the management of warehouse operations, including inventory tracking, demand forecasting, and stock replenishment. The system 200 integrates real-time inventory monitoring, automated workflows, and machine learning algorithms to enhance efficiency and accuracy in inventory handling.

The server 202 may include suitable logic, circuitry, interfaces, and/or code configured to obtain a plurality of raw time series datasets comprising operational transactions indicative of inventory outflow from a warehouse. Examples of the server 202 may include, but are not limited to, a cloud server, an application server, a database server, a file server, a storage server or a combination thereof. Furthermore, the server 202 may either be a single hardware server or a plurality of hardware servers operating in a parallel or distributed architecture to ensure reliable access, scalability, and efficient performance of the system 200.

The client device 204 may include suitable logic, circuitry, interfaces, and/or code configured to interact with the server 202 in order to obtain an actionable demand forecast for inventories of the warehouse using a selected forecasting model for each time series category to minimize out-of-stock and overstocking in the warehouse. Examples of the client device 204 may include, but are not limited to, a smartphone, tablet, laptop, desktop computer, wearable device, or any other network-enabled device.

The communication network 206 may include suitable logic, circuitry, interfaces, and/or protocols configured to enable the transmission and reception of data between devices, such as the client device 204 and the server 202, over the communication network 206. Examples of the communication network 206 may include, but are not limited to, a cellular network (e.g., a 5G, or 5G NR network), a cloud network, a Local Area Network (LAN), a Metropolitan Area Network (MAN), a wide area network (WAN), and/or the Internet.

The processor 208 may include suitable logic, circuitry, interfaces, and/or code configured to execute various tasks related to inventory management, data processing, and communication within the system 200. The processor 208 is responsible for interpreting and executing instructions that enable the management of inventory, demand forecasting, and resource allocation. The processor 208 may be configured to perform tasks, such as processing incoming data from client devices or sensors, executing forecasting algorithms, managing database queries, and coordinating communication between different components of the warehouse management system. In an implementation, the processor 208 may refer to one or more individual processors, processing devices, and various elements associated with a processing device that may be shared by other processing devices. Examples of the processor 208 may include but are not limited to a central processing unit (CPU), a microcontroller, an integrated circuit, a co-processor, a microprocessor, a complex instruction set computing (CISC) processor, an application-specific integrated circuit (ASIC) processor, a reduced instruction set (RISC) processor, a very long instruction word (VLIW) processor, a digital signal processor (DSP), a data processing unit, and other processors or circuits, and the like.

FIG. 2B is a block diagram illustrating various exemplary components of a server, in accordance with an embodiment of the present disclosure. FIG. 2B is described in conjunction with elements from FIGS. 1A to 1H and 2A. With reference to FIG. 2B, there is shown a block diagram of the server 202 (of FIG. 2A) comprising the processor 208. The server 202 further includes a categorization logic module 210, a seasonality module 212, a holiday module 214, a weather module 216, a promotion module 218, a hybrid model selection module 220, a voting ensemble module 222, a memory 224, and a network interface 226. There is further shown a client 228 configured to access the client device 204. The voting ensemble module 222 further comprises a plurality of estimators 222A and a voting regressor 222B.

The categorization logic module 210 may include suitable logic, circuitry, interfaces, and/or code configured to classify or group time series datasets into distinct categories or classes based on predefined criteria or characteristics. The categorization logic module 210 involves analyzing raw time series datasets and determining which group or category the time series datasets belong to, based on the specific attributes of seasonality, product type, demand patterns, or other relevant features. In an implementation scenario, the categorization logic module 210 may either be a software or a hardware or a combination thereof.

The seasonality module 212 may include suitable logic, circuitry, interfaces, and/or code configured to capture and account for recurring patterns or cycles in data that occur at regular intervals, typically related to specific seasons, months, weeks, or even days. The seasonality module 212 identifies these periodic trends, such as increased demand during holidays, weather-related changes, or seasonal promotions, and incorporates them into the training dataset. In an implementation scenario, the seasonality module 212 may either be a software or a hardware or a combination thereof.

The holiday module 214 may include suitable logic, circuitry, interfaces, and/or code configured to account for the impact of holidays on demand patterns. Holidays often lead to significant changes in consumer behavior, such as increased or decreased demand for certain products or services. The holiday module 214 identifies holidays, special events, or other calendar-based occurrences, and adjusts the demand forecast accordingly to reflect these shifts. In an implementation scenario, the holiday module 214 may either be a software or a hardware or a combination thereof.

The weather module 216 may include suitable logic, circuitry, interfaces, and/or code configured to incorporate weather-related factors into demand predictions. The weather conditions, such as temperature, precipitation, and seasonal changes can significantly impact consumer behavior and demand for certain products or services. For example, the extreme weather may increase demand for heating products during cold months or influence consumer preferences for specific clothing or outdoor goods. The weather module 216 analyzes historical weather data and real-time weather forecasts to identify patterns or correlations between weather conditions and demand. In an implementation scenario, the weather module 216 may either be a software or a hardware or a combination thereof.

The promotion module 218 may include suitable logic, circuitry, interfaces, and/or code configured to account for the impact of promotional activities on demand. The promotions, such as discounts, sales events, and marketing campaigns, can lead to significant changes in consumer purchasing behavior, often causing demand spikes for specific products or services. The promotion module 218 tracks and analyzes past promotional events, their timing, and their effects on demand, using this historical data to adjust future forecasts. In an implementation scenario, the promotion module 218 may either be a software or a hardware or a combination thereof.

The hybrid model selection module 220 refers to a module configured to provide an actionable demand forecast for inventories of the warehouse for each time series category to minimize out-of-stock and overstocking in the warehouse. The hybrid model selection module 220 typically involves evaluating the performance of various existing models, such as statistical, machine learning, or time series models, based on the historical data and forecasting accuracy. In an implementation scenario, the hybrid model selection module 220 may either be a software or a hardware or a combination thereof.

The voting ensemble module 222 is a technique within a forecasting or machine learning system that combines the predictions from multiple models to generate a final, aggregated output. The voting ensemble module 222 typically uses strategies such as majority voting, where the most frequent prediction is selected, or weighted voting, where predictions from models that have historically performed better, are given more weightage.

The plurality of estimators 222A refers to a collection of different estimation models or methods used within the system 200 to generate multiple independent predictions. Each estimator of the plurality of estimators 222A is designed to process the input data using different techniques, algorithms, or approaches. These estimators can be based on varying statistical models, machine learning algorithms, or other predictive methods, each contributing a unique perspective to the demand forecast.

The voting regressor 222B is a model used in machine learning and forecasting systems to combine the predictions of multiple regression models. The voting regressor 222B aggregates the outputs of several individual regression models (i.e., “voters”) to produce a final prediction.

The memory 224 may include suitable logic, circuitry, interfaces and/or code that is configured to store machine code and/or instructions executable by the processor 208. Examples of implementation of the memory 224 may include, but are not limited to, an Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory.

The network interface 226 may include suitable logic, circuitry, interfaces and/or code that is configured to facilitate communication between each component of the system 200. The network interface 226 enables the server 202 to communicate with the client device 204. Examples of the network interface 226 may include, but are not limited to, an antenna, a transceiver, a radio-frequency transceiver, and the like.

The client 228 refers to an individual or entity configured to access the client device 204. In the system 200, the client 228 may either be an individual person or an organization, configured to utilize the system's outputs to make informed decisions.

In operation, the system 200 of warehouse inventory management aims to improve inventory forecasting and optimize warehouse operations. The system 200 comprises the processor 208 configured to perform several key steps. Firstly, the processor 208 is configured to obtain a plurality of raw time series datasets, which include operational transactions that reflect inventory outflow from the warehouse. The processor 208 is further configured to pre-process the raw time series datasets by applying filters to remove data gaps exceeding a predetermined duration, datasets with no recent activity, and those with insufficient historical records, ensuring the use of reliable and complete data. The pre-processed datasets are then categorized into a number of categories based on distinct inventory ordering patterns, creating categorized time series datasets. These datasets are further enriched by inserting data variables related to the seasonality pattern, the holiday effect, the weather-related features, and the promotional effects, all of which influence inventory outflow. The processor 208 is further configured to dynamically select an appropriate forecasting model to output an actionable demand forecast for warehouse inventory management. This demand forecast aims to minimize both out-of-stock and overstocking situations, ensuring efficient inventory management and enhancing the decision-making process for warehouse operations.

The system 200 of warehouse inventory management, comprises the processor 208 configured to obtain a plurality of raw time series datasets comprising operational transactions indicative of inventory outflow from the warehouse. The acquisition of raw time series datasets containing operational transactions provides required historical patterns of inventory movement, enabling the system 200 to understand and analyze temporal distribution trends. These temporal patterns serve as foundational data points that capture the actual flow of resources through the supply chain network, reflecting both regular cycles and anomalous events that influence inventory dynamics.

The processor 208 is further configured to pre-process the plurality of raw time series datasets to generate a training dataset by filtering two or more of: data gaps exceeding a predetermined duration, datasets lacking recent activity, and a type of data records that are less than a predefined threshold quantity. The pre-processing of raw time series datasets through systematic filtering ensures the training dataset contains only high-quality, relevant temporal patterns by eliminating incomplete sequences, outdated records, and statistically insignificant data points. This data refinement step is crucial for model performance as the pre-processing prevents the forecasting model from learning from corrupted or non-representative patterns, thereby establishing a more reliable foundation for generating accurate predictions.

In accordance with an embodiment, the processor 208 is configured to pre-process the plurality of raw time series datasets by applying the gap filter to eliminate the data gaps exceeding the predetermined duration, applying the recency filter to remove the datasets lacking recent activity, and applying the minimum data filter to ensure historical operational transaction records are greater than the predefined threshold quantity.

The processor 208 is further configured to categorize the pre-processed plurality of raw time series datasets into a number of categories based on distinctive ordering patterns of inventories of the warehouse to generate categorized time series datasets. The categorization of pre-processed time series datasets based on distinctive ordering patterns enables the system 200 to identify and group similar inventory movement behaviors, allowing for more specialized and targeted analysis of each pattern type. This segmentation approach recognizes that different categories of inventory may exhibit unique temporal characteristics, cyclical patterns, or volatility levels, thereby enabling the selection of the most appropriate forecasting model for each distinct category.

In accordance with an embodiment, the processor 208 is configured to categorize the pre-processed plurality of raw time series datasets by extracting features comprising annual frequency and operational transactions history for each time series dataset, calculating percentile-based cutoff values for the annual frequency and the operational transactions history, removing outliers from each time series dataset based on the calculated percentile-based cutoff values and classifying the pre-processed plurality of raw time-series datasets into the number of categories based on the calculated percentile-based cutoff values to generate the categorized time series datasets. More specifically, the categorization logic module 210 is configured to categorize the pre-processed plurality of raw time series datasets by extracting features of annual frequency and operational transactions history for each time series dataset. The categorization causes the generation of well-defined groups of time series datasets, each representing distinct inventory characteristics. The structured classification allows for tailored forecasting models to be applied to each category, enhancing the accuracy and relevance of inventory predictions and improving overall inventory management of the warehouse.

The processor 208 is further configured to process the categorized time series datasets to generate an augmented training dataset based on inserting data variables associated with seasonality patterns, holiday effects, weather-related features and promotional effects that collectively influence the inventory outflow from the warehouse. The augmentation of categorized time series data with contextual variables captures the complex interplay of external factors that influence inventory movement patterns, creating a richer and more comprehensive training dataset. By incorporating seasonality, holiday periods, weather conditions, and promotional events, the system 200 develops a more nuanced understanding of the multiple forces that drive inventory dynamics, enabling the system 200 to generate more accurate and contextually aware predictions.

In accordance with an embodiment, the processor 208 is further configured to incorporate the seasonality patterns by applying time series decomposition on the categorized time series datasets to extract seasonality components, determining annual seasonality lag components using the categorized time series datasets with a null hypothesis indicative of an absence of annual seasonality correlation and an alternate hypothesis indicative of a presence of an annual seasonality correlation greater than a threshold. The processor 208 is further configured to combine the determined annual seasonality lag components to the plurality of raw time series datasets to generate the augmented training dataset. More specifically, the seasonality module 212 is configured to incorporate the seasonality patterns into the training dataset for generation of the augmented training dataset. By incorporating the seasonality patterns into the training dataset, the system 200 ensures that the forecasting model captures predictable demand fluctuations, leading to more reliable and precise inventory management decisions.

In accordance with an embodiment, the processor 208 is further configured to incorporate the weather-related features by integrating three types of weather datasets comprising an actual weather dataset, a weather forecast dataset, and a climatology dataset, and generating continuous weather features comprising temperature, snowfall, and precipitation measurements based on the integrated weather datasets. The processor 208 is further configured to incorporate the weather-related features by calculating weather anomalies by comparing the actual weather dataset and the weather forecast dataset against the climatology dataset, generating categorical weather features using equal-width and equal-volume binning techniques and integrating the generated continuous weather features and the categorical weather features to the training dataset to generate the augmented training dataset. More specifically, the weather module 216 is configured to incorporate the weather-related features into the training dataset to generate the augmented training dataset for the forecasting model. By incorporating the generated continuous weather features and the categorical weather features to the training dataset to generate the augmented training dataset, the forecasting model can account for weather-driven demand fluctuations, resulting in more accurate and actionable inventory predictions.

In accordance with an embodiment, the processor 208 is further configured to incorporate the promotional effects by transforming a plurality of raw promotional datasets into a standardized format, extracting promotional features comprising promotional duration, promotional category, promotional price, promotional quantity, and everyday value based on the standardized format and integrating the extracted promotional features into the training dataset to generate the augmented training dataset. More specifically, the promotion module 218 is configured to incorporate the promotional features into the training dataset to generate the augmented training dataset for the forecasting model. By incorporating the extracted promotional features into the training dataset of the forecasting model, the forecasting model gains the ability to analyze and predict how various promotional strategies affect demand, enabling more precise inventory management and reducing risks associated with overstocking or stockouts during promotional periods.

The processor 208 is further configured to dynamically select a forecasting model from a plurality of available forecasting models for each time series dataset based on the categorization and the augmented training dataset. The dynamic selection of forecasting models based on data categorization and augmented features ensures that each time series pattern is analyzed using the most suitable algorithmic approach, optimizing prediction accuracy for different types of inventory behavior. This adaptive model selection recognizes that no single forecasting algorithm is optimal for all patterns, and instead leverages the distinct characteristics of each category and its enriched features to match it with the most appropriate predictive methodology.

In accordance with an embodiment, the processor 208 is configured to dynamically select the forecasting model by implementing a two-layer selection process, wherein the processor 208 is further configured to assign the forecasting model to predefined time series categories based on volume contribution percentages and perform a packaging group level selection by evaluating historical accuracy reports within a dynamic window of defined number of weeks relative to a forecast week. The processor 208 is further configured to select the forecasting model for specific packaging group-delivery plant combinations based on the evaluated accuracy reports maintain consistency of the selected forecasting model within packaging group-delivery plant combinations and generate the actionable demand forecast using the selected forecasting model. The processor 208 is configured to generate the actionable demand forecast using the selected forecasting model, providing precise and reliable predictions tailored to the unique characteristics of the inventory, thereby supporting efficient warehouse management and decision-making. More specifically, the hybrid model selection module 220 is configured to dynamically the the forecasting model which is further configured to generate the actionable demand forecast.

The processor 208 is further configured to output an actionable demand forecast for the inventories of the warehouse using the selected forecasting model for each time series category to minimize out-of-stock and overstocking in the warehouse. The generation of actionable demand forecasts through category-specific models enables precise predictions that account for the unique characteristics and patterns of different inventory types, leading to optimized stock levels across the distribution network. This targeted forecasting approach, tailored to each time series category, produces more accurate predictions of resource requirements, thereby enabling proactive inventory management and reducing the likelihood of supply-demand imbalances.

In an implementation scenario, the actionable demand forecast may be used for an automated inventory replenishment. The system 200 automatically generates purchase orders when inventory levels approach predetermined thresholds based on the actionable demand forecast. The system 200 may further be configured to perform a dynamic adjustment of reorder points and quantities based on predicted demand patterns and integrate with supplier systems for streamlined order processing. The system 200 may further be configured to perform an automated scheduling of deliveries based on predicted inventory depletion rates and lead times.

In another implementation scenario, the actionable demand forecast may be used for real-time inventory distribution optimization. The continuous monitoring and reallocation of inventory across distribution centers can be done based on localized demand forecast. The system 200 may be configured to perform a dynamic adjustment of safety stock levels based on the predicted demand volatility. The system 200 may generate automated alerts for potential stockout risks or excess inventory situations. The system 200 may perform optimization of cross-dock operations based on predicted regional demand patterns.

In yet another implementation scenario, the actionable demand forecast may be used for warehouse space and resource management. The dynamic allocation of warehouse storage space can be done based on predicted inventory levels. Furthermore, the automated scheduling of warehouse staff can be done based on predicted picking and packing volumes. The system 200 may perform optimization of picking routes based on predicted order patterns and may lead to proactive maintenance scheduling for material handling equipment based on predicted usage patterns. The system 200 may perform real-time adjustment of storage locations based on predicted turnover rates.

In accordance with an embodiment, the processor 208 is further configured to update the actionable demand forecast by obtaining a plurality of demand forecasts generated from the plurality of available forecasting models for each time series dataset. The processor 208 is further configured to process the obtained plurality of demand forecasts through an ensemble weighting mechanism, wherein each individual forecast is evaluated against historical forecast performance patterns and weights are dynamically assigned to each forecast based on the historical accuracy and relevance to the specific time series category. Furthermore, the processor 208 is configured to combine the weighted forecasts using a multi-model aggregation technique that leverages a collective predictive intelligence of the available forecasting models, and generate an updated actionable demand forecast by synthesizing the aggregated model outputs. By integrating the weighted forecasts using a multi-model aggregation technique, the processor 208 generates the updated actionable demand forecast that is more comprehensive and precise. This refined forecast helps to optimize inventory planning, reducing the risk of stockouts or overstocking, and enhancing the overall efficiency of warehouse operations.

The system's multi-layered data preprocessing and pattern categorization capabilities enable highly refined and contextually aware predictions by systematically filtering low-quality data and grouping similar temporal patterns. The dynamic integration of external variables, including seasonality, weather conditions, and promotional events, creates an enriched training dataset that captures the complex interplay of factors influencing inventory movement patterns. The system's intelligent model selection mechanism adapts to different types of time series patterns by automatically choosing the most appropriate forecasting algorithm for each category, ensuring optimal prediction accuracy across diverse inventory behaviors. Furthermore, the system's ability to generate category-specific actionable forecasts enables precise resource allocation, minimizing supply-demand imbalances and optimizing distribution network efficiency through automated, data-driven decision making.

The system 200 may have a significant practical utility in modern inventory management through automated, data-driven decision making. The weather module 216 enables precise stock adjustments based on weather-related demand fluctuations, while the promotion module 218 allows accurate inventory planning around marketing activities. The hybrid model selection module 220 ensures optimal forecasting accuracy by automatically choosing the best predictive model for each product category and location combination. These capabilities directly address common inventory challenges by reducing stockouts during peak demand periods and minimizing excess inventory during slower periods.

The system's cloud-based architecture facilitates real-world implementation across large distribution networks. For example, a beverage distributor could use the weather module 216 to automatically adjust inventory levels before a heatwave, while the promotion module 218 simultaneously accounts for planned marketing campaigns. The hybrid forecasting approach would automatically select the most accurate prediction model based on historical performance patterns, enabling precise stock level optimization across different product categories and warehouse locations. This integration of multiple data sources and automated decision-making significantly reduces manual intervention while improving forecast accuracy and operational efficiency.

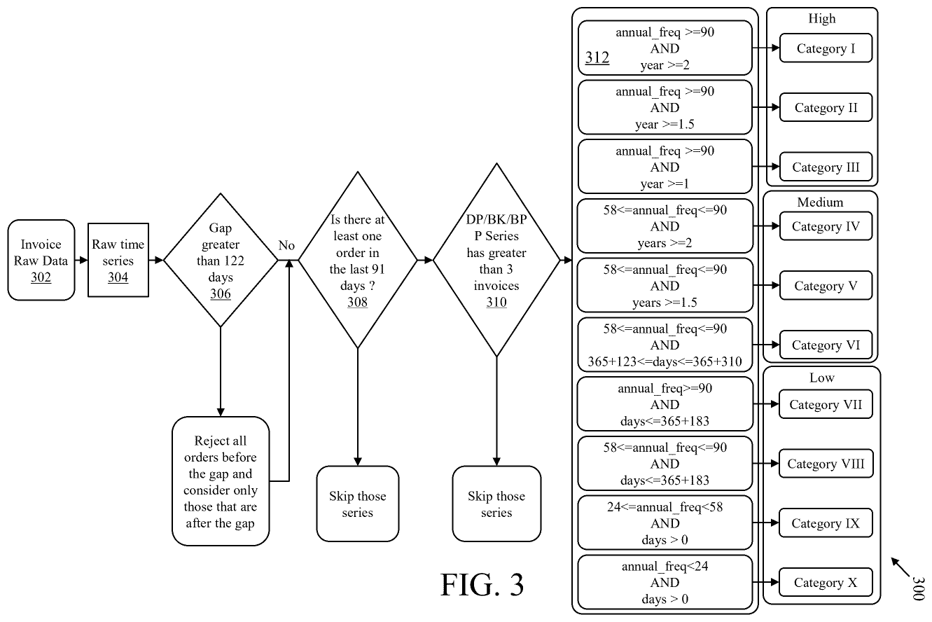

FIG. 3 is a flowchart that depicts a series of operations performed by a categorization logic module, in accordance with an embodiment of the present disclosure. FIG. 3 is described in conjunction with elements from FIGS. 1A to 1H, 2A and 2B. With reference to FIG. 3, there is shown a flowchart 300 that depicts a series of operations 302-312 performed by the categorization logic module 210.

At operation 302, the raw invoice data which serves as a foundational data source for warehouse inventory management is obtained. The raw invoice data comprises the historical invoices or transaction records that provide critical insights into actual demand and consumption patterns for products or materials stored in the warehouse. By capturing real-time consumption and reflecting historical usage trends, the raw invoice data enables the identification of peaks, troughs, and consistent patterns in demand. This information forms the baseline for subsequent data processing and forecasting, ensuring accurate demand estimation and efficient inventory optimization.

At operation 304, the raw time series datasets are obtained by extracting individual combinations of Delivery Plant (DP), Budget Key Account (BKA), and Batch Product/Packaging (BPP) groups from the raw invoice data. These combinations represent distinct time series datasets, each corresponding to a unique set of identifiers that reflect the operational structure of inventory and distribution.

At operation 306, the gap filter is applied to refine the time series datasets by removing sequences with gaps exceeding 122 days. The gap filtering is used to ensure that the data used for analysis and forecasting is continuous and relevant. Specifically, any raw invoice data preceding such a gap is discarded, and only the data generated after the identified gap is retained.

At operation 308, the recency filter is applied on the time series datasets to examine the invoices generated in the last 91 days (from the pipeline run date). The time series combinations without recent invoices are excluded from further analysis.

At operation 310, the minimum invoice filter is applied on the timeseries datasets, which ensures that there is sufficient data for each combination to enable accurate analysis and forecasting.

At operation 312, after the pre-processing, certain features are extracted including annual frequency that means invoice generation frequency and historical patterns of transactions, to understand the demand patterns. To categorize the processed time series datasets, cutoff values for these features are set using the percentile-based method, ensuring a consistent approach across all time-series datasets. Thereafter, the pre-processed time series datasets are categorized into a number of categories, for example, ten categories, as shown in FIG. 3. The categorization is performed on the basis of two key attributes, that is average annual frequency of invoices and the historical pattern of the time series datasets. The categorization ensures that time series datasets with similar characteristics are grouped together into three categories, namely, “High”, “Medium” and “Low” category, enabling the selection of an appropriate forecasting model for each category. For example, the “High” category is defined by time series datasets with an average annual frequency of invoices greater than 90 and an ordering history of spanning greater than equal to, for example, 1, 1.5 and 2 years. The “Medium” category comprises those time series datasets with an average annual frequency between 90 and 58 and an ordering history of spanning of 1.5 to 2 years, and 365+123<=days<=365+310. The “Low” category comprises those time series datasets with an average annual frequency of less than 90 and greater than 24 and an ordering history of spanning less than 1.5 years (e.g., annual freq>=90 AND days<=365+183, 58<=annual freq<=90 AND days<=365+183, 24<=annual freq<=58 AND days>0, annual freq<=24 AND days>0). The categorization approach is dynamic, and the distribution of time series datasets across different categories can change over time as more data is accumulated. Additionally, the categorization approach incorporates specific threshold values and filters, such as the gap filter, recency filter, and minimum invoice filter that collectively enhance the quality and reliability of the input data.

For example, in the given flowchart 300, the pre-processed time series datasets are categorized into ten categories which are then grouped into three categories, namely High, Medium and Low categories depending on threshold values of the annual frequency and historical patterns of transactions. The High category (I, II, III), includes the datasets with the annual frequency (e.g., 90 or above) and sufficient historical continuity. The Medium category (IV, V, VI) includes datasets with a moderate yearly frequency (e.g., between 58 and 90) and varying levels of historical continuity. And the Low category (VII, VIII, IX, X) includes datasets with lower annual frequency (e.g., below 58) and minimal continuity of history.

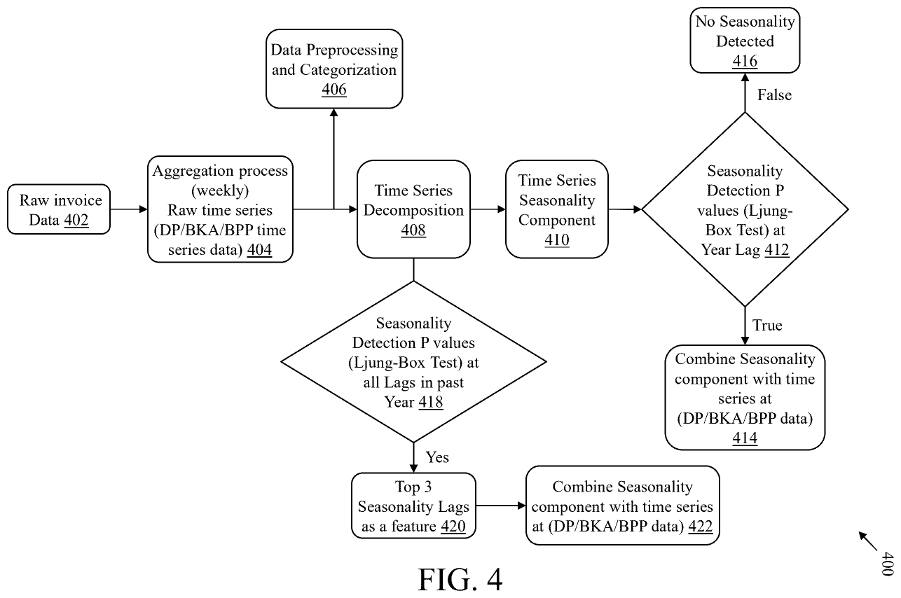

FIG. 4 is a flowchart that depicts a series of operations performed by a seasonality module, in accordance with an embodiment of the present disclosure. FIG. 4 is described in conjunction with elements from FIGS. 1A to 1H, 2A, 2B and 3. With reference to FIG. 4, there is shown a flowchart 400 that depicts a series of operations 402 to 422 performed by the seasonality module 212.

At operation 402, raw invoice data is obtained.

At operation 404, aggregation of raw invoice data is performed. The raw invoice data is aggregated at different levels, for example, stock keeping units (SKUs) level, delivery plant level, budget key accounts (BKA) level, batch product packaging (BPP) level, and the like, ensuring that the data reflects the operational nuances of each unique combination. The aggregation of time series datasets is performed on weekly basis.

At operation 406, the weekly aggregated time series datasets are pre-processed and categorized into different categories depending on the cutoff values of the annual frequency and historical patterns of the time series datasets, have been described in detail, for example, in FIG. 3.

At operation 408, the pre-processed and categorized time series datasets are subjected to time-series decomposition which is used to decompose a time series dataset into distinct components, each representing different underlying patterns in data. Each time series dataset has three components, namely, level (which represents the baseline value of each time series dataset), seasonality (which reflects recurring patterns or fluctuations at regular intervals), trend (which captures the long-term directional movement) and noise (which accounts for random variations or unexplained data points). Mathematically, the time series decomposition can be expressed as:

$$time series = Level + Trend + Seasonality + Noise$$

At operation 410, monthly aggregated time series datasets are obtained and subjected to time series decomposition to fetch the seasonality component of the same.

At operation 412, the seasonality module 212 is configured to execute Ljung Box Test on the fetched seasonality component to evaluate autocorrelation at lags in the seasonality component. The seasonality lags represent the recurring patterns or trends in the datasets at specific time intervals, such as weekly, monthly, or yearly cycles. The seasonality lags capture the intervals at which the datasets exhibit repetitive behavior, providing valuable insights into the temporal structure of the time series datasets. For example, a lag of 7 days might indicate weekly seasonality, where patterns repeat every week, while a lag of 30 days could point to monthly seasonality, reflecting trends that occur once a month. The Ljung-Box Test is a statistical test used to detect the presence of autocorrelation in a time series. The autocorrelation refers to the correlation between a time series and a lagged version of itself.

The Ljung Box test works under the following hypotheses: the null hypothesis, in which it is assumed that the data shows no significant annual seasonality (i.e., no correlation over a yearly period), while the alternative hypothesis posits that the data shows significant correlation over an annual basis.

At operation 414, if the Ljung-Box Test confirms the presence of the annual seasonality, the seasonality component is then left-joined with the time series datasets aggregated at different levels, such as the SKU level, the BKA level, delivery plant level, and the like and used in the demand forecasting.

At operation 416, if the Ljung-Box Test confirms the absence of the annual seasonality.

At operation 418, the seasonality module 212 is configured to look at all lags in time series in past year at weekly aggregation level and run Ljung-Box Test with same null hypothesis.

At operation 420, the seasonality module 212 is configured to select the top three correlated lags with time series and combine them with the time series datasets aggregated at different levels, such as the SKU level, the BKA level, delivery plant level, and the like and used in the demand forecasting, at operation 422. Alternatively, may be stated as, the selected top three correlated lags are combined with the training dataset to generate the augmented training dataset used in forecasting.

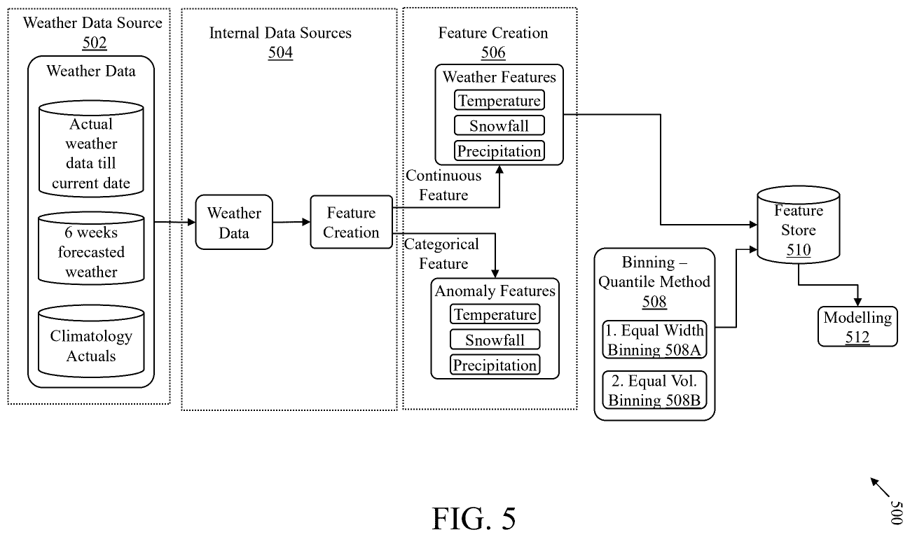

FIG. 5 is a flow chart that depicts a series of operations performed by a weather module, in accordance with an embodiment of the present disclosure. FIG. 5 is described in conjunction with elements from FIGS. 1A to 1H, 2A, 2B, 3 and 4. With reference to FIG. 5, there is shown a flowchart 500 that depicts a series of operations 502 to 512 performed by the weather module 216.

The weather module 216 begins at operation 502, with the weather data source, which incorporates three distinct data components: an actual weather dataset maintained until the current date, a 6-week forecasted weather dataset, and climatology actuals (containing expected/normal weather values with 4-year update cycles).

At operation 504, these three internal data sources are consolidated into the weather data component, which feeds directly into a feature creation process.

At operation 506, the feature creation process generates two primary categories of weather features: i) continuous features, comprising temperature measurements, snowfall measurements and precipitation measurements, ii) categorical features, comprising anomaly features for temperature anomalies, snowfall anomalies and precipitation anomalies.

At operation 508, the binning-quantile method is applied to transform these features, utilizing two distinct approaches.

At operation 508A, the weather module 216 implements equal width binning, which segments the data range into intervals of uniform size. For example, a temperature range of 0-100 degrees divided into five equal bins would create intervals of 20 units each.

At operation 508B, the weather module 216 employs equal volume binning, which creates intervals containing equal numbers of data points, adjusting bin widths based on data distribution to ensure uniform data point distribution across bins.

At operation 510, the processed features are stored in a feature store, serving as a centralized repository for the transformed weather data.

Finally, at operation 512, the data flows into the modelling phase, where the processed weather features are utilized for predictive analysis.

This comprehensive weather data preprocessing pipeline creates a structured flow from raw weather data through feature creation and transformation, ultimately preparing the data for integration with demand forecasting models. The weather module 216 combines current weather data, short-term forecasts, and long-term climatological patterns to create a robust set of features for predictive modeling. The prepared weather features are joined with the training dataset in the modelling phase, the prepared weather features are combined with training dataset based on the location of the Budget key account. This merged dataset is then utilized for model training, enhancing the predictive capabilities of the overall demand forecasting.

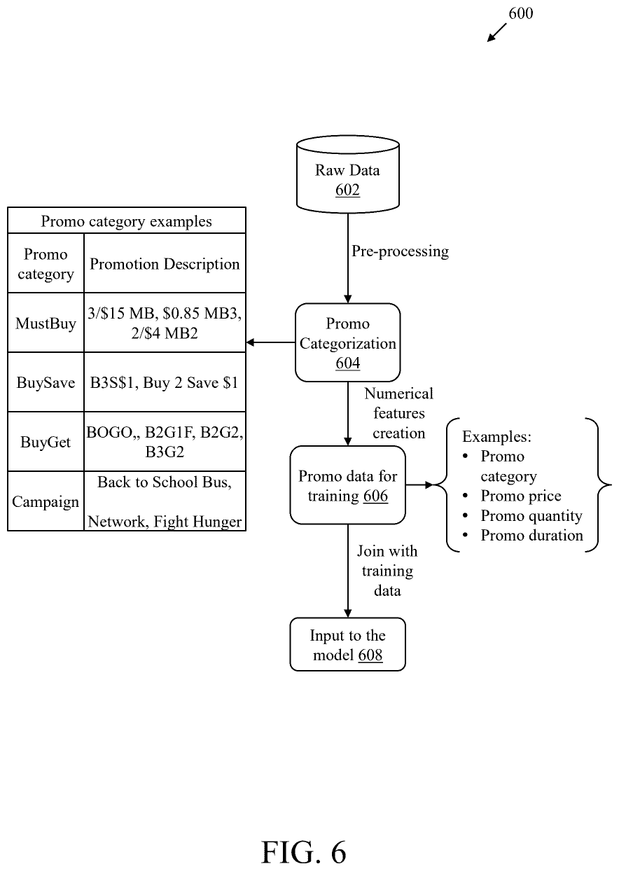

FIG. 6 is a flowchart that depicts a series of operations performed by a promotion module, in accordance with an embodiment of the present disclosure. FIG. 6 is described in conjunction with elements from FIGS. 1A to 1H, 2A, 2B, 3, 4 and 5. With reference to FIG. 6, there is shown a flowchart 600 that depicts a series of operations 602 to 608 performed by the promotion module 218.

At operation 602, the process begins with raw promotional datasets, which comprises excel sheets containing promotional information that are manually maintained and updated weekly by planners with 6-week forward-looking promotional plans.

At operation 604, the promo categorization phase classifies the raw promotional datasets into distinct categories, for example,
MustBuy: Encompasses promotions such as “3/$15 MB”, “$0.85 MB3”, and “2/$4 MB2”
BuySave: Includes offers like “B3S$1” and “Buy 2 Save $1”
BuyGet: Contains promotions such as “BOGO (Buy One Get One)”, “B2GIF (Buy Two Get One Free)”, “B2G2 (Buy Two Get Two)”, and “B3G2 (Buy Three Get Two)”
Campaign: Comprises promotional events like “Back to School Bus”, “Children's Miracle Network”, and “Fight Hunger”.

At operation 606, the promotional datasets for training generates numerical features including the promotional category, the promotional price, the promotional quantity and the promotional duration.

At operation 608, input to the forecasting model represents the final stage where the processed promotional data is joined with the training data for model ingestion

Referring to FIG. 6, the promotion module 218 presents a streamlined workflow that transforms the raw promotional datasets into structured model inputs through four key operations. The process initiates with raw promotional datasets at the operation 602, proceeds through promotional categorization at the operation 604, continues with numerical feature creation at the operation 606, and concludes with model input preparation at the operation 608. The workflow incorporates pre-processing of the raw data and creation of numerical features before joining with the training data. This systematic approach ensures that promotional data is properly processed and structured before being utilized as input for the model. Since multiple promotions can apply in the same week, a custom encoding method is used to avoid duplicating rows and ensure multiple promo details are captured in a single data entry. The promo price reflects the discounted price under the promotion, while the promotional quantity represents the quantity eligible for the promo, such as “3” in a “3 for $13” deal. The EDV is also included as a numerical feature, derived during data processing to indicate the product's regular price without a promotion. Finally, the processed data, now enriched with these features, is combined with demand data and ingested into the machine learning model.

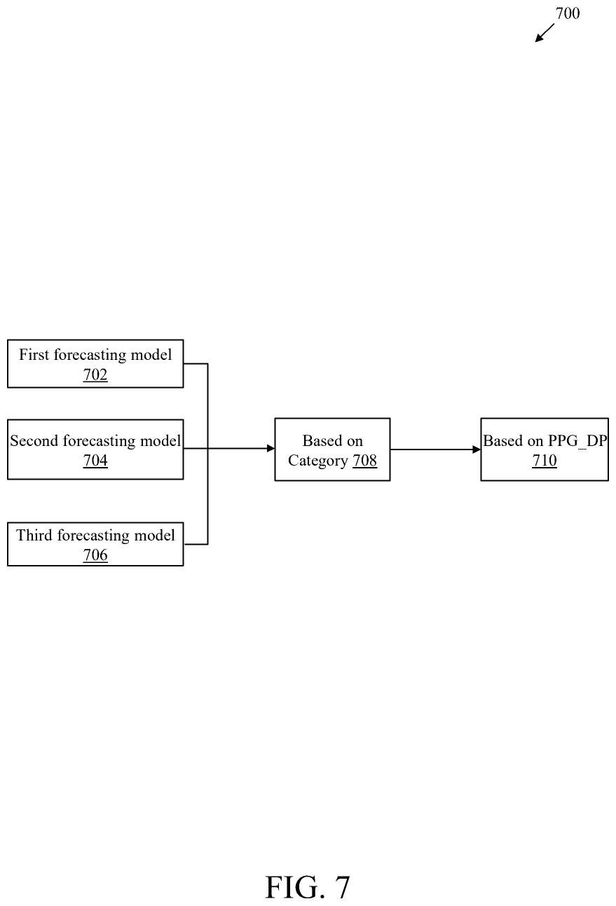

FIG. 7 is a flowchart that depicts a series of operations performed by a hybrid model selection module, in accordance with an embodiment of the present disclosure. FIG. 7 is described in conjunction with elements from FIGS. 1A to 1H, 2A, 2B, 3, 4, 5 and 6. With reference to FIG. 7, there is shown a flowchart 700. There is shown a first forecasting model 702, a second forecasting model 704 and a third forecasting model 706. There is further shown two operations, 708 and 710 performed by the hybrid model selection module 220.

The first forecasting model 702 (e.g., Prophet) is an open-source forecasting library, designed for flexible time series modeling.

The second forecasting model 704 (e.g., LightGBM) is an efficient gradient-boosting framework that employs tree-based learning algorithms, optimized for processing large-scale data.

The third forecasting model 706 (e.g., AutoARIMA) is an automated time series forecasting model that automatically determines appropriate ARIMA model parameters without manual intervention. The autoARIMA approach automatically identifies the appropriate ARIMA model structure (p, d, q) for a given time series, without requiring manual model selection and parameter tuning.

At operation 708, “Based on Category,” represents the first level of model selection, where specific models are assigned to each category according to the established categorization logic. This approach allows for dynamic model assignment as time series can shift between categories based on accumulated data patterns.

At operation 710, “Based on PPG_DP,” represents the second level of selection focusing on PackagingGroup-DeliveryPlant combinations. This level refines model selection based on observed performance patterns specific to these combinations.

Referring to FIG. 7, the hybrid model selection module 220 implements a two-tier selection process utilizing three forecasting models (Prophet, LightGBM, and AutoARIMA) to optimize prediction accuracy. The selection process ensures that only one model is applied per time series (SKU-BudgetKeyAccount-DeliveryPlant combination), first at the category level at the operation 708 and then, refined at the PackagingGroup-DeliveryPlant level at the operation 710. This approach accommodates both the dynamic nature of category-based selection and the specific behavioral patterns observed at the packaging group and delivery plant levels, ultimately improving overall forecast accuracy.

An exemplary scenario of selection of the forecasting model at the category level is shown, for example, in Table 1:

TABLE 1

| Category | | Weekly Vol Contribution % | Model |
|---|---|---|---|
| High | I | 90.79 | Prophet |
| | II | 5.31 | Prophet |
| | III | 0.98 | LightGBM |
| Medium | IV | 0.61 | AutoARIMA |
| | V | 0.14 | Prophet |
| Low | VII | 1.30 | AutoARIMA |
| | VIII | 0.07 | LightGBM |
| | IX | 0.57 | AutoARIMA |
| | X | 0.19 | AutoARIMA |

An exemplary scenario of selection of the forecasting model at the packaging group-delivery plant level is shown, for example, in Table 2:

TABLE 2

| | DP | | | |
|---|---|---|---|---|
| PPG | Plant 1 | Plant 2 | Plant 3 | Plant 4 |
| PG1 | c | Prophet | LightGBM | c |
| PG2 | c | LightGBM | LightGBM | LightGBM |
| PG4 | c | c | LightGBM | c |
| PG7 | LightGBM | LightGBM | c | c |
| PG8 | c | c | LightGBM | c |
| PG9 | c | LightGBM | LightGBM | AutoARIMA |
| PG10 | c | LightGBM | LightGBM | c |
| PG11 | c | c | LightGBM | c |
| PG16 | AutoARIMA | LightGBM | Prophet | c |
| PG17 | c | LightGBM | LightGBM | LightGBM |
| PG20 | c | AutoARIMA | LightGBM | c |
| PG26 | LightGBM | AutoARIMA | AutoARIMA | c |
| PG27 | LightGBM | c | LightGBM | c |
| PG31 | c | LightGBM | c | Prophet |
| PG45 | Prophet | LightGBM | LightGBM | LightGBM |
| PG62 | c | c | c | c |

where c represents category-wise selection and Prophet/LightGBM/AutoARIMA-Model selected based on Packaging Group level selection.

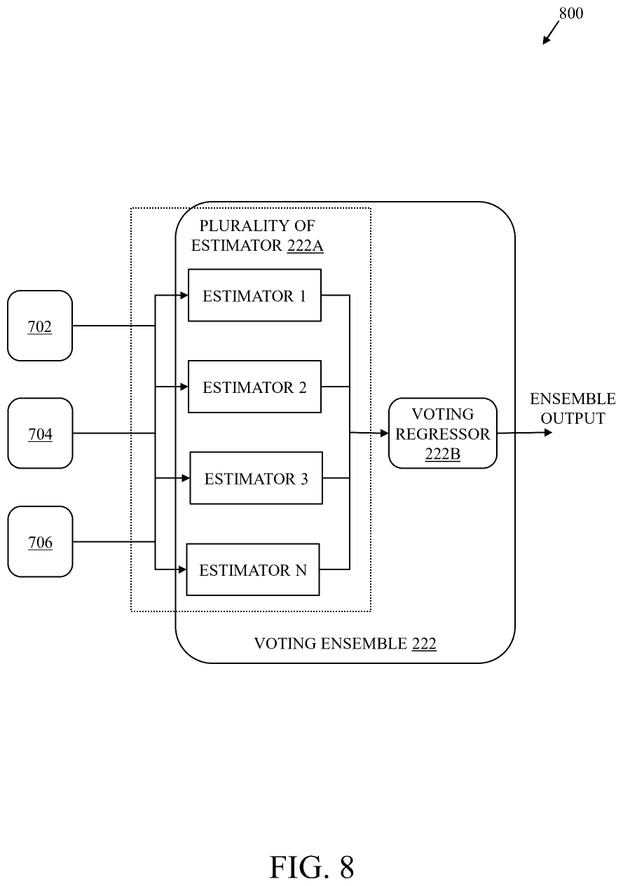

FIG. 8 is a flowchart that depicts a series of operations performed by a voting ensemble module, in accordance with an embodiment of the present disclosure. FIG. 8 is described in conjunction with elements from FIGS. 1A to 1H, 2A, 2B, 3, 4, 5, 6, and 7. With reference to FIG. 8, there is shown a flowchart 800 that depicts a series of operations performed by the voting ensemble module 222.

The voting ensemble module 222 incorporates multiple forecasting models (i.e., the first forecasting model 702, the second forecasting model 704 and the third forecasting model 706) into a unified prediction framework. The voting ensemble module 222 includes two main components that is the plurality of estimators 222A and the voting regressor 222B.

The plurality of estimators 222A comprises multiple estimators (e.g., estimator 1 through estimator N) configured to process the forecasts generated by the individual models. These estimators have been specifically trained on historical forecast patterns to evaluate and refine the predictions.

The voting regressor 222B is configured to aggregate and synthesize the outputs from all estimators to produce an ensemble output. This systematic combination of multiple predictive inputs leverages collective model intelligence to generate a more robust and accurate final forecast.

Referring to FIG. 8, the voting ensemble module 222 demonstrates how the system integrates predictions from various forecasting models through multiple specialized estimators. The architecture is designed to harness the strengths of different predictive approaches while mitigating their individual limitations, ultimately producing a more reliable forecast than what could be achieved by any single model operating independently.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A method (100) of warehouse inventory management, comprising:
obtaining a plurality of raw time series datasets comprising operational transactions indicative of inventory outflow from a warehouse;
pre-processing the plurality of raw time series datasets to generate a training dataset by filtering two or more of: data gaps exceeding a predetermined duration, datasets lacking recent activity, and a type of data records that are less than a predefined threshold quantity;
categorizing the pre-processed plurality of raw time series datasets into a number of categories based on distinctive ordering patterns of inventories of the warehouse to generate categorized time series datasets;
processing the categorized time series datasets to generate an augmented training dataset based on inserting data variables associated with seasonality patterns, holiday effects, weather-related features and promotional effects that collectively influence the inventory outflow from the warehouse;
dynamically selecting a forecasting model from a plurality of available forecasting models for each time series dataset based on the categorization and the augmented training dataset; and
outputting an actionable demand forecast for the inventories of the warehouse using the selected forecasting model for each time series category to minimize out-of-stock and overstocking in the warehouse.

2. The method (100) according to claim 1, wherein pre-processing the plurality of raw time series datasets comprises:
applying a gap filter to eliminate the data gaps exceeding the predetermined duration;
applying a recency filter to remove the datasets lacking recent activity; and
applying a minimum data filter to ensure historical operational transaction records are greater than the predefined threshold quantity.

3. The method (100) according to claim 1, wherein categorizing the pre-processed plurality of raw time series datasets comprises:
extracting features comprising annual frequency and operational transactions history for each time series dataset;
calculating percentile-based cutoff values for the annual frequency and the operational transactions history;
removing outliers from each time series dataset based on the calculated percentile-based cutoff values; and
classifying the pre-processed plurality of raw time-series datasets into the number of categories based on the calculated percentile-based cutoff values to generate the categorized time series datasets.

4. The method (100) according to claim 1, wherein selecting the forecasting model comprises:
implementing a two-layer selection process comprising:
assigning the forecasting model to predefined time series categories based on volume contribution percentages; and
performing a packaging group level selection by evaluating historical accuracy reports within a dynamic window of defined number of weeks relative to a forecast week, and selecting the forecasting model for specific packaging group-delivery plant combinations based on the evaluated accuracy reports;
maintaining consistency of the selected forecasting model within packaging group-delivery plant combinations; and
generating the actionable demand forecast using the selected forecasting model.

5. The method (100) according to claim 1, wherein incorporating the seasonality patterns comprises:
applying time series decomposition on the categorized time series datasets to extract seasonality components;
determining annual seasonality lag components using the categorized time series datasets with a null hypothesis indicative of an absence of annual seasonality correlation and an alternate hypothesis indicative of a presence of an annual seasonality correlation greater than a threshold value; and
combining the determined annual seasonality lag components to the plurality of raw time series datasets to generate the augmented training dataset.

6. The method (100) according to claim 1, wherein incorporating the weather-related features comprises:
integrating three types of weather datasets comprising an actual weather dataset, a weather forecast dataset, and a climatology dataset;
generating continuous weather features comprising temperature, snowfall, and precipitation measurements based on the integrated weather datasets;
calculating weather anomalies by comparing the actual weather dataset and the weather forecast dataset against the climatology dataset;
generating categorical weather features using equal-width and equal-volume binning techniques; and
integrating the generated continuous weather features and the categorical weather features to the training dataset to generate the augmented training dataset.

7. The method (100) according to claim 1, wherein incorporating the promotional effects comprises:
transforming a plurality of raw promotional datasets into a standardized format;
extracting promotional features comprising promotional duration, promotional category, promotional price, promotional quantity, and everyday value based on the standardized format; and
integrating the extracted promotional features into the training dataset to generate the augmented training dataset.

8. The method (100) according to claim 7, wherein extracting the promotional features further comprises implementing a customized one-hot encoding approach to incorporate multiple overlapping promotional features within a single time period.

9. The method (100) according to claim 1, wherein incorporating the holiday effects comprises:
generating a first holiday feature by marking specific calendar dates as regular holidays;
generating a second holiday feature by adjusting holiday dates to next nearest Sunday to align with weekly aggregated data;
identifying holiday-related demand patterns by:
calculating quantile-based threshold values for each time series dataset;
flagging time periods where demand exceeds the calculated threshold values; and
correlating the flagged time periods with holiday occurrences; and
integrating the generated holiday features and identified holiday-related demand patterns into the training dataset.

10. The method (100) according to claim 1, further comprising updating the actionable demand forecast by:
obtaining a plurality of demand forecasts generated from the plurality of available forecasting models for each time series dataset;
processing the obtained plurality of demand forecasts through an ensemble weighting mechanism, wherein each individual forecast is evaluated against historical forecast performance patterns and weights are dynamically assigned to each forecast based on the historical accuracy and relevance to the specific time series category;
combining the weighted forecasts using a multi-model aggregation technique that leverages a collective predictive intelligence of the available forecasting models; and
generating an updated actionable demand forecast by synthesizing the aggregated model outputs.

11. The method (100) according to claim 3, wherein categorizing the pre-processed plurality of raw time series datasets into the number of categories further comprises:
monitoring changes in each of the categorized time series datasets over time; and
automatically reassigning the categories based on the monitored changes.

12. The method (100) according to claim 11, wherein selecting of the forecasting model further comprises:
automatically reselecting the forecasting model based on category transitions; and
maintaining consistency of the reselected forecasting model within packaging group and delivery plant combinations.

13. A system (200) of warehouse inventory management, comprises:
a processor (208) configured to:
obtain a plurality of raw time series datasets comprising operational transactions indicative of inventory outflow from a warehouse;
pre-process the plurality of raw time series datasets to generate a training dataset by filtering two or more of: data gaps exceeding a predetermined duration, datasets lacking recent activity, and a type of data records that are less than a predefined threshold quantity;
categorize the pre-processed plurality of raw time series datasets into a number of categories based on distinctive ordering patterns of inventories of the warehouse to generate categorized time series datasets;
process the categorized time series datasets to generate an augmented training dataset based on inserting data variables associated with seasonality patterns, holiday effects, weather-related features and promotional effects that collectively influence the inventory outflow from the warehouse;
dynamically select a forecasting model from a plurality of available forecasting models for each time series dataset based on the categorization and the augmented training dataset; and
output an actionable demand forecast for the inventories of the warehouse using the selected forecasting model for each time series category to minimize out-of-stock and overstocking in the warehouse.

14. The system (200) according to claim 13, wherein the processor (208) is configured to pre-process the plurality of raw time series datasets by:
applying a gap filter to eliminate the data gaps exceeding the predetermined duration;
applying a recency filter to remove the datasets lacking recent activity; and
applying a minimum data filter to ensure historical operational transaction records are greater than the predefined threshold quantity.

15. The system (200) according to claim 13, wherein the processor (208) is configured to categorize the pre-processed plurality of raw time series datasets by:
extracting features comprising annual frequency and operational transactions history for each time series dataset;
calculating percentile-based cutoff values for the annual frequency and the operational transactions history;
removing outliers from each time series dataset based on the calculated percentile-based cutoff values; and
classifying the pre-processed plurality of raw time-series datasets into the number of categories based on the calculated percentile-based cutoff values to generate the categorized time series datasets.

16. The system (200) according to claim 13, wherein the processor (208) is configured to dynamically select the forecasting model by:
implementing a two-layer selection process, wherein the processor (208) is further configured to:
assign the forecasting model to predefined time series categories based on volume contribution percentages; and
perform a packaging group level selection by evaluating historical accuracy reports within a dynamic window of defined number of weeks relative to a forecast week, and selecting the forecasting model for specific packaging group-delivery plant combinations based on the evaluated accuracy reports;
maintain consistency of the selected forecasting model within packaging group-delivery plant combinations; and
generate the actionable demand forecast using the selected forecasting model.

17. The system (200) according to claim 13, wherein the processor (208) is further configured to incorporate the seasonality patterns by:
applying time series decomposition on the categorized time series datasets to extract seasonality components;
determining annual seasonality lag components using the categorized time series datasets with a null hypothesis indicative of an absence of annual seasonality correlation and an alternate hypothesis indicative of a presence of an annual seasonality correlation greater than a threshold; and
combining the determined annual seasonality lag components to the plurality of raw time series datasets to generate the augmented training dataset.

18. The system (200) according to claim 13, wherein the processor (208) is further configured to incorporate the weather-related features by:
integrating three types of weather datasets comprising an actual weather dataset, a weather forecast dataset, and a climatology dataset;
generating continuous weather features comprising temperature, snowfall, and precipitation measurements based on the integrated weather datasets;
calculating weather anomalies by comparing the actual weather dataset and the weather forecast dataset against the climatology dataset;
generating categorical weather features using equal-width and equal-volume binning techniques; and
integrating the generated continuous weather features and the categorical weather features to the training dataset to generate the augmented training dataset.

19. The system (200) according to claim 13, wherein the processor (208) is further configured to incorporate the promotional effects by:
transforming a plurality of raw promotional datasets into a standardized format;
extracting promotional features comprising promotional duration, promotional category, promotional price, promotional quantity, and everyday value based on the standardized format; and
integrating the extracted promotional features into the training dataset to generate the augmented training dataset.

20. The system (200) according to claim 13, wherein the processor (208) is further configured to update the actionable demand forecast by:
obtaining a plurality of demand forecasts generated from the plurality of available forecasting models for each time series dataset;
processing the obtained plurality of demand forecasts through an ensemble weighting mechanism, wherein each individual forecast is evaluated against historical forecast performance patterns and weights are dynamically assigned to each forecast based on the historical accuracy and relevance to the specific time series category;
combining the weighted forecasts using a multi-model aggregation technique that leverages a collective predictive intelligence of the available forecasting models; and
generating an updated actionable demand forecast by synthesizing the aggregated model outputs.
